(19) United States
(12) Patent Application Publication
(10) Pub. No.: US 2026/0246651 A1
(43) Pub. Date: Aug. 20, 2026

(54) SYSTEMS AND METHODS FOR IDENTITY VERIFICATION AND ASSURANCE BASED ON FAIR WITNESS NETWORKS

(71) Applicant: Legendary Requirements, Inc., Ventura, CA (US)

(72) Inventors: Joseph ANDRIEU, Ventura, CA (US); William ABRAMSON, London (GB)

(73) Assignee: Legendary Requirements, Inc., Ventura, CA (US)

(21) Appl. No.: 19/540,034

(22) Filed: Feb. 13, 2026

Related U.S. Application Data
(60) Provisional application No. 63/758,526, filed on Feb. 14, 2025.

(51) Int. Cl. H04L 9/32

(52) U.S. Cl. CPC H04L 9/3247

(57) ABSTRACT

Disclosed herein are techniques for identity validation. Techniques include creating a digital fair witness credential for a subject based on evidence of identity of the subject; signing the created credential; producing an evidence data object including the evidence of identity and the digital fair witness credential; encrypting the evidence data object; storing the encrypted evidence data object; making accessible, to a fair witness network, a fair witness record corresponding to the digital fair witness credential and the evidence, where the fair witness record is cryptographically associated with the signed digital fair witness credential; receiving, from a confirming device, a digitized validation request; and providing the fair witness record to the confirming device without revealing the evidence of identity, where the record is usable by the confirming device to validate a credential provided locally to the confirming device as related to the signed digital fair witness credential.

### RELATED APPLICATION

This application claims priority under 35 U.S.C. § 119 to U.S. Provisional Application No. 63/758,526, filed on Feb. 14, 2025, which is expressly incorporated herein by reference in its entirety.

### TECHNICAL FIELD

Embodiments relate generally to systems and methods for identity verification and assurance.

### BACKGROUND

Despite the growing importance of digital interactions in modern society, the frustrating problem of identity assurance remains unsolved. In other words, it is a significant challenge for a digital service provider to know with 100% certainty that the person initiating a specific interaction is, in fact, authorized to do so. Current solutions require over-sharing personal information that is unrelated to the issue at hand, such as providing a driver's license along with a home address just to prove age eligibility to access a website. It is nearly impossible to know who is on the other side of a digital interaction without compromising privacy.

Current best practices use cryptographic identifiers to issue and verify claims made by trusted authorities. For example, Decentralized Identifiers (DIDs) and Verifiable Credentials (VCs) use modern cryptography to enable a three-party identity model:
1. Issuers issue credentials about Subjects to those subjects after the subject has proven control of a cryptographic identifier used to refer to the subject.
2. Subjects present those credentials to Relying Parties along with proof of control of the subject identifier.
3. Relying Parties, also known as verifiers, who verify the authenticity of the credential and validate the claims against known issuers and business requirements.

This three-party model uses modern cryptography for identity assurance and verification. The present systems and methods build on this three-party model, enabling public accountability for private evaluations of identity assertions.

In view of the technical deficiencies of current systems, there is a need for improved systems, cryptography, and combinations of operations for validating identities, especially given the increasing sophistication of identity spoofing. The techniques discussed below satisfy these and other technical needs.

### SUMMARY

Embodiments of the present disclosure provide a process comprising the steps of generating, by a fair witness entity using a fair witness device, a signed digital fair witness credential to a subject after evaluating evidence satisfying the requirements of a fair witness protocol; storing, by an archive module, the documentation of identity as evidence and the signed digital fair witness credential; publishing, by a fair witness network system, a fair witness record corresponding to the signed fair witness credential and the evidence evaluated by the fair witness entity; presenting, by the identity subject, at least one signed fair witness credential, to a system of a relying party such as an employer website; verifying, by a confirming device of the relying party, that the content of the presented fair witness credential produces the same cryptographic hash secured by the cryptographic proof, thus establishing that the credential received by the relying party has not been tampered with since issuance; and validating, by a confirming device of the relying party, that the presented digital fair witness credential has been registered by a certified digital fiduciary on the fair witness network by locating the fair witness record associated with the digital fair witness credential and cryptographically establishing that the record applies to the presented credential; and auditing, using an auditor device, the fair witness record published in the fair witness network.

A fair witness credential may comprise any credential issued by a fair witness after evaluating evidence that satisfies a specific fair witness protocol. In some embodiments, the fair witness credentials may be generated by a protocol satisfying U.S. Citizenship and Immigration Services (USCIS) I-9 proof of eligibility to work in the United States or any protocol defined by the Digital Fiduciary Association, such as a proof of unique personhood protocol. Fair witness credentials may be generated according to any format that satisfies the protocol, including World Wide Web Consortium (W3C) Verifiable Credentials and ISO mDocs (18013-5), but is not limited thereto.

The steps and components disclosed herein may be illustrated through the concrete, exemplary embodiment of the generating (e.g., issuance), presentation, and audit of a signed digital USCIS I-9 fair witness credential. Other applications and examples within the spirit of the systems, methods and processes disclosed herein, are possible as those skilled in the art will appreciate.

In some embodiments, the protocol may utilize an in-person interaction with both the fair witness entity and the identity subject present. The fair witness entity, such as an individual, may see secret data and moderate what does and does not get recorded, according to protocol. In other embodiments, the interaction with the subject person may be with an automated system, run by a fiduciary. An in-person protocol may enable 100% air-gapped data retention-no data ever leaves the control of the fair witness, while an automated online system typically requires using a network. For example, a user may go to a semi-private public location and use an ATM to complete a fair witness protocol, and the ATM may use 100% local analytics (e.g., Optical Character Recognition and image processing), storing the evidence in a manner that cannot be retrieved from the network while still publishing the record on the fair witness network. In this case, the ATM must be able to initiate outbound network traffic to register the record, but it does not need to allow incoming connections.

### BRIEF DESCRIPTION OF THE DRAWINGS

The accompanying drawings, which are incorporated in and constitute a part of this specification, illustrate several embodiments and, together with the description, serve to explain the disclosed principles. The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a schematic diagram illustrating components of a system and method for identity verification and assurance based on a fair witness network, according to one embodiment.

FIG. 2 depicts a schematic diagram illustrating a subject device and data objects related to the subject device for operating a system and method for identity verification and assurance, according to one embodiment.

FIG. 3 depicts a schematic diagram illustrating a fair witness device and data objects related to the fair witness for operating a system and method for identity verification and assurance, according to one embodiment.

FIG. 4 depicts a schematic diagram illustrating an offline archive and data objects related to the offline archive for operating a system and method for identity verification and assurance, according to one embodiment.

FIG. 5 depicts a schematic diagram illustrating a fair witness network node and data objects related to the fair witness network node for operating a system and method for identity verification and assurance, according to one embodiment.

FIG. 6 depicts a schematic diagram illustrating an employer website and data objects related to the employer website for operating a system and method for identity verification and assurance, according to one embodiment.

FIG. 7 depicts a schematic diagram illustrating an onsite check-in system (employer system) and data objects related to the onsite check-in system for operating a system and method for identity verification and assurance, according to one embodiment.

FIG. 8 depicts a schematic diagram illustrating a Digital Fiduciary Association (DFA) intranet and data objects related to the DFA intranet for operating a system and method for identity verification and assurance, according to one embodiment.

FIG. 9 depicts a schematic diagram illustrating an auditor device and data objects related to the auditor device for operating a system and method for identity verification and assurance, according to one embodiment.

FIG. 17 depicts a schematic diagram illustrating a confirming device and data objects related to the confirming device for operating a system and method for identity verification and validation, according to one embodiment.

FIGS. 10A to 10C depict a flowchart of requesting, by a data subject, a digital fair witness credential (e.g., a digital U.S. Citizenship and Immigration Services (USCIS) I-9 fair witness verifiable credential (VC)), which is evaluated by a fair witness according to a fair witness protocol, according to one embodiment.

FIGS. 11A and 11B depict a flowchart of digitally onboarding, by the data subject, with a relying party (e.g., an employer) through their website using the digital fair witness credential (e.g., the digital USCIS I-9 fair witness VC), according to one embodiment. The relying party uses a confirming device to verify and validate the digital fair witness credential.

FIG. 12 depicts a flowchart of in-person onboarding where the employer meets in person with the subject who has remotely onboarded and check the subject's identity using information collected, according to one embodiment.

FIGS. 13A to 13C depict a flowchart of auditing, by a auditing fair witness using an auditor device, a fair witness record published in the fair witness network, according to one embodiment.

FIG. 14 shows a block diagram and process of an exemplary system and device in which an embodiment may be implemented.

FIG. 15 depicts a high-level signal flow block diagram for network system in which an embodiment may be implemented.

FIG. 16 depicts a cloud computing environment for implementing an embodiment of the system and process disclosed herein.

### DETAILED DESCRIPTION OF EXEMPLARY EMBODIMENTS

The following description is made for the purpose of illustrating the general principles of the embodiments disclosed herein and is not meant to limit the concepts disclosed herein. Further, particular features described herein can be used in combination with other described features in each of the various possible combinations and permutations. Unless otherwise specifically defined herein, all terms are to be given their broadest possible interpretation including meanings implied from the description as well as meanings understood by those skilled in the art and/or as defined in dictionaries, treatises, etc. While embodiments below may be described with respect to the exemplary figures, it is appreciated that this is for demonstrating the disclosed techniques and that the exemplary embodiment associated with each figure is not necessarily limited to the combination and configuration of elements depicted therein. For example, some elements may not be present, some elements may be duplicated, and/or different connections (or lack thereof) between elements may be present.

Embodiments of the systems, methods and processes disclosed herein can hold evaluating parties publicly accountable for cryptographic attestations without publicly revealing the evidence used, by using the evidence that may be digitally recorded during an event, such as an in-person ceremony. It is appreciated that associating evidence information with a fair witness credential, associated with a subject, permits the re-evaluation of that evidence by a second, independent digital fiduciary. This allows third party confirmation that the original evidence justifies the claims, without revealing that evidence (e.g., to the public). This evidence may be private information, the disclosure of which may violate the privacy of the subject. An embodiment of the systems, methods, and processes disclosed herein provides public accountability for private verifications, enabling in-person, physical ceremonies to underpin digital interactions in any context without unnecessarily revealing personal information.

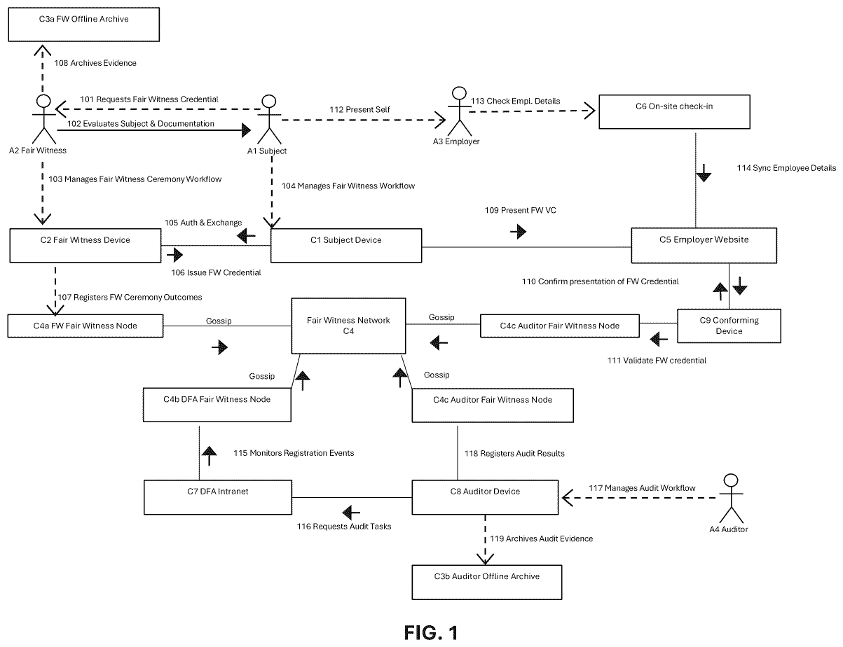

FIG. 1 depicts a schematic diagram illustrating components of a system and method/process for identity verification and assurance based on a fair witness network, according to one embodiment. The fair witness network-based system and method 100 may include an ecosystem that uses the fair witness network to issue, verify, and audit fair witness credentials. The fair witness network may include the nodes participating in consensus of some state. FIG. 1 also shows communication between the components of the invention. With reference to FIG. 1, the components of the present fair witness network-based system and method 100 may include actors (e.g., A1 to A4), device components (e.g., C1 to C9), and actions (e.g., steps 101 to 119), which support the issuance, verification, and audit of fair witness credentials. The fair witness credentials may be any credential created by a fair witness after satisfying a specific fair witness protocol. In some embodiments, the fair witness credentials may be a U.S. Citizenship and Immigration Services (USCIS) I-9 Verifiable Credential or any other credential issued after satisfying a protocol defined by the Digital Fiduciary Association, such as a proof of unique personhood protocol. Fair witness credentials may be generated according to any format that satisfies the protocol, including World Wide Web Consortium (W3C) Verifiable Credentials and ISO mDocs (18013-5), but is not limited thereto.

The I-9 is a document for Employment Eligibility Verification required by the USCIS and used by U.S. employers to verify the identity and legal authorization of individuals hired for employment in the United States.

The present systems and methods are described herein with an example of a USCIS I-9 Verifiable Credential as a digital fair witness credential, but a digital fair witness credential that the present systems and methods may utilize for evaluation of evidence of identity is not limited thereto. For example, while certain embodiments may refer to specific types of credentials or records, such as a USCIS I-9 form, it is appreciated that the same techniques may be applied to other types of credentials, records, and/or information. As mentioned above, the digital fair witness credentials may be any credential created according to a defined fair witness protocol, such as a USCIS I-9 credential or a proof of personhood credential.

The primary flows for the present system and method may include generating, presenting (or digital verification), and auditing, where generating a fair witness credential means creating, then cryptographically signing a digital object of a particular format, e.g., a W3C Verifiable Credential. For the steps of generating, a Subject (A1) may engage a fair witness (A2) to request a fair witness credential, e.g., a digital USCIS I-9, providing documentation (Step 101). Then, the fair witness (A2) may evaluate the Subject (A1) and documentation provided using a fair witness device (C2) (Step 102) to manage an event (e.g., fair witness ceremony) workflow (Step 103). The Subject (A1) may manage a fair witness workflow directly using their subject device (C1) (Step 104) to directly authenticate with the fair witness device (C2) and set up an exchange channel (Step 105). The fair witness device (C2) may also be configured to create digital fair witness credential for the Subject (A1), based on evidence of identity of the subject (e.g., according to an established fair witness protocol). The fair witness device may also be configured to digitally sign the digital fair witness credential, using at least one cryptographic identifier, which may be associated (e.g., publicly) with the fair witness and/or the fair witness device (e.g., validating its authority, genuineness, etc.). In some embodiments, the fair witness device may verify, e.g., prior to generating the digital fair witness credential, that the at least one cryptographic subject identifier is under the control of the subject (e.g., A1) or a subject device.

In some embodiments, at least one of the digital fair witness credential or the fair witness device is controllable by or controlled by a recognized fair witness and/or registered with the fair witness network. A fair witness may be considered an authenticated and/or trusted entity, which may be verifiable through cryptographic means, digital signatures, and the like, consistent with disclosed embodiments.

In some embodiments, the fair witness device may also produce an evidence data object, which may include the evidence of identity and the signed digital fair witness credential.

Then, the fair witness device (C2) may issue (e.g., transmit) the resulting fair witness credential, digital USCIS I-9, over the exchange channel directly to the subject device (C1) (Step 106).

The fair witness device (C2) then may make accessible (e.g., register, publish, store) a record of the event (e.g., fair witness ceremony) as a fair witness record on a fair witness network via its own fair witness node (C4a) (Step 107). In this case, a gossip protocol may be used to register on the fair witness network via the fair witness node (C4a). The fair witness network may be a decentralized system within which a public, consensus-based state is maintained by nodes. For example, nodes within the fair witness network may each maintain a state of the network and/or information maintained in the network, such as credential information, record information, or any digital information related to a subject. By using a consensus-based approach, information maintained within the network may be much less susceptible to tampering or other forms of malicious manipulation. The gossip protocol may be used by nodes on the network to communicate with each other, such as to maintain one or more states between the nodes. Each node may also expose an API for authorized parties to query the node (e.g., transmit a request for information, such as fair witness records published to the network). The node may return information (e.g., on-chain, cryptographically secure, etc.), such as a cryptographically bound record (e.g., indicating information that was received or verified at a particular event), that a client device (e.g., confirming device) may be configured to validate. Validating a credential (e.g., establishing that the credential was legitimately recorded, is trustworthy, and/or reflects information reliably recorded at an event) may use significant amounts of cryptographic computation that would be impracticable for a human to perform. The initial fair witness (A2), the employer (A3), the DFA intranet (C7), and auditing fair witness (A4) all may be free to use any node of the fair witness network that allows them to do so, including running their own. The diagram in FIG. 1 shows different nodes for each of those parties to highlight that decentralized feature.

The fair witness (A2) may also archive the evidence in its own secure fair witness archive (C3) (Step 108). In some embodiments, the archived evidence may be associated with a protocol that defines parameters for restoring data based on the archived evidence.

The next step may be presenting a credential (e.g., likely the issued fair witness credential) to a relying party (e.g., an employer, A3) for an onboarding process, or onboarding event (Step 109). In some embodiments, the subject (A1) may present an identity claim and a proof from the digital fair witness credential issued to them to a system (C5) (e.g., an employer website) of the relying party (e.g., an employer, A3).

Then, the employer (A3) may confirm that a presented credential is authentic by verifying the proof on the credential and validating that the credential is a legitimate fair witness credential. In some embodiments, the validation may include transmitting a digitized request to a fair witness device and/or fair witness network node. The request may be for a record associated with a presented digital fair witness credential, a signed digital fair witness credential associated with a presented digital fair witness credential, an evidence data object, a data bundle, or any other information usable for the verification and/or validation. For example, the employer may use a confirming device to validate that the presented digital fair witness credential has been registered or published by a certified digital fiduciary on the fair witness network by locating the fair witness record cryptographically associated with the digital fair witness credential. In some embodiments, the confirming device may use the proof on a digital fair witness credential to verify that the credential is cryptographically equivalent to the fair witness credential signed by a fair witness device. Such a verification may be based on cryptographic material associated with the, at least one, cryptographic identifier used to sign the credential (e.g., by the device that generated the credential and/or at the event at which the credential was generated).

In some embodiments, the confirming device may be configured to verify that a source (e.g., subject/A1) providing the locally provided credential has access to the cryptographic material associated with at least one cryptographic identifier.

It is appreciated that cryptographically associating a record on the fair witness network with a digital credential, may allow for any entity with access to the credential to reliably request that record without communicating directly with either the initial fair witness or the original issuer of documentary evidence used at an event (e.g., the issuer of a driver's license in a fair witness ceremony), thereby reducing the privacy harms from overcommunicating with issuers during credential validation, also known as “phone home”. Moreover, this technique allows an entity to cryptographically verify that a digital credential (associated with the record) was properly registered on the fair witness network by a fair witness device as part of a fair witness event.

The onboarding process with the relying party (e.g., the employer, A3) may be separated from onsite verification of the physical person. To onboard, the Subject (A1) may present their fair witness credential to the Employer website (C5) (Step 109) using their subject device (C1).

The employer website (C5) may use a confirming device (C9) to confirm the presentation of the fair witness credential (Step 110). Confirmation includes verification of the cryptographic signatures and validation that the credential is a fair witness credential. For example, a confirming device (C9) may check the fair witness network to ensure the credential has been registered by a recognized digital fiduciary by querying a fair witness node directly, including a node they run themselves (Step 111). In some embodiments, a gossip protocol may be used to maintain a node's local state, using blockchain consensus protocols to resolve temporal ordering of records processed by potentially adversarial peer nodes (e.g., C4d). It is appreciated that blockchain-based embodiments provide for a unique global consensus mechanism that allows for shared state among potentially adversarial collaborators without the need for a centralized authority.

This fair witness presentation (Step 109) may use or require the transmittal of one or more images secured by that Verifiable Credential. For example, the image may be embedded in the credential directly or referenced by a URL with a cryptographic hash to ensure the image retrieved from the URL is the image intended. When such images are transmitted those images may be stored for use later during onsite verification of the physical person (Step 113). In some embodiments, the exchange may not need the presentation of images from that Verifiable Credential. In this case, those images should be requested on-site to verify the physical person is the Subject (A1) of the credential and the relying party (A3) should check the cryptographic hash of the image reference in the fair witness credential against an independent calculation using the provided image.

The next step may be onsite verification. When first appearing on-site, the Subject (e.g., an employee, A1) may physically present themselves to the Employer (A3) (Step 112). The employer (A3) may check the employee (A1) against records of employee details on an onsite check-in system (e.g., an employer system, C6) (Step 113) to see if they, in fact, match any of the onboarded individuals via the onboard processes. The employer website (C5) may maintain a list of current employees including in-person authentication options, such as an image of the subject, by synchronizing employee details with an onsite check-in system (C6) (Step 114). In some embodiments, the Subject (A1) may present themselves on-site and provide their name; the employer (A3) may look up that name and compare the recorded photo from the onboarding process. However, it is understood that other on-site authentication mechanisms may be used to link the person onsite with the subject (A1) of the fair witness credential. For example, if it is desirable to avoid storing photos of individual subjects, the employer (A3) may choose to exclude the images from the onboarding event and instead use or require them for onsite verification, via exchange of a digitally verifiable credential. In another embodiment, the employer (A3) may use visual analytics (e.g., executed by a computing device) to compare the subject (A1) with images on file, even potentially supporting fully remote verification.

The present system and method may also include the steps of Auditing. The Digital Fiduciary Association (DFA) intranet (C7) may monitor the registration events on the fair witness network via its own fair witness node (C4b) (Step 115). In this case, a gossip protocol may be used to monitor the registration events on the fair witness network via the DFA fair witness node (C4b). The DFA intranet (C7) may maintain a list of audit tasks available for assignment, allowing auditing entities such as Auditors (A4) to request or claim specific audit tasks (Step 116) to then perform the associated audits (e.g., using a device). An audit process, which may be performed at least in part by a machine, may produce an audit result, which may indicate whether an auditing entity (e.g., device, system, network) achieved a same data result as a presented data result (e.g., data verification, data authenticity, etc.). The auditor (A4) may use their own auditor device (C8) to request audit tasks (Step 116) and manage the workflow of individual audits (Step 117); the result of each audit may be registered on the fair witness network via the Auditor (A4)'s own fair witness node (C4c) (Step 118), and the supporting evidence may be archived in the Auditor's own fair witness Offline Archive (C3b) (Step 119). In this case, a gossip protocol may be used to register the audit results on the fair witness network via the Auditor fair witness node (C4c). Registering audit results on the fair witness network, to form a consensus-based state, consistent with disclosed embodiments, may increase the authenticity of the audited information in a decentralized yet rapidly verifiable manner not achievable through conventional techniques.

Registering audit results (Step 118) on the fair witness network, in the same manner as registering fair witness outcomes (Step 107) enables all audit results to also be audited, ensuring that audit results are themselves accountable using subsequent audits. For example, the procedures, results, actions performed, and any other aspect of an audit can be audited according to the processes mentioned above with respect to other data.

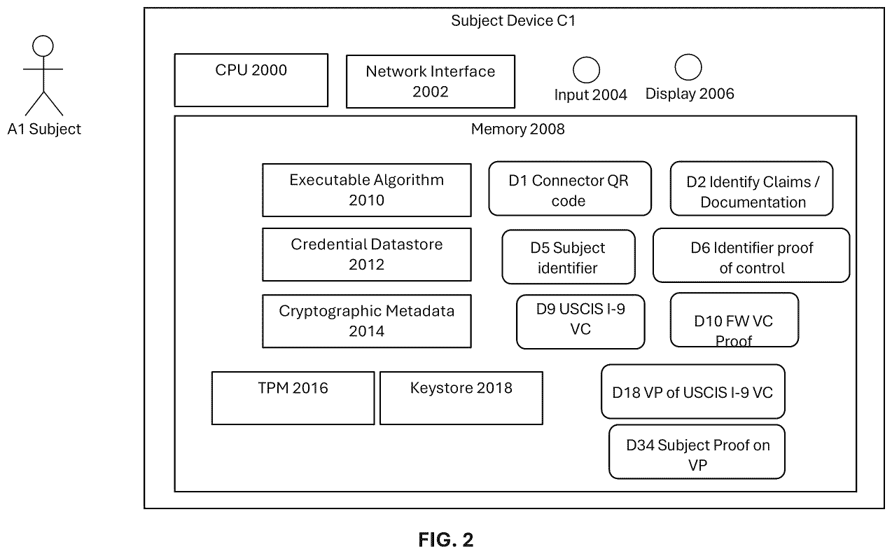

FIGS. 2 to 9 and FIG. 17 depict schematic diagrams illustrating data objects used in the actions (steps 101 to 119, FIG. 1) of the actors (A1 to A4) and the device components (C1 to C9) for operating a system and method for identity verification and assurance based on a fair witness network (e.g., nodes C4a, C4b, C4c, C4d), according to some embodiments.

FIG. 2 depicts a schematic diagram illustrating a subject device and data objects related to the subject device for operating a system and method for identity verification and assurance, according to one embodiment. With reference to FIG. 2, the subject device (C1) may be controlled by the subject (A1) and used to create connection QR codes (D1), manage subject identifiers (D5) and one or more identifier proofs of control over them (D6), receive and store verifiable credentials and the proofs (D9, D10) and create one or more verifiable presentations (VP) of these credentials (D18). The VP (D18) may include at least one claim, at least one proof (D10) derived from the credential (D9) that demonstrates the authenticity of the credential as issued, and/or at least one proof (D34) for verifying the VP itself is created by the Subject (A1).

Exemplary subject device C1 may include at least one processor (e.g., CPU 2000), network interface 2002, input 2004 (e.g., input device), display 2006, and memory 2008, which may include one or more separate memory components. Subject device C1 may receive (e.g., via network interface 2002 and/or input 2004), and/or memory 2008 may store, data such as executable algorithm 2010, credential datastore 2012, cryptographic metadata 2014, TPM 2016, keystore 2018, connection QR code D1, identity claims/documentation D2, subject identifier D5, identifier proof of control D6, USCIS I-9 VC D9, FW VC Proof D10, VP of USCIS I-9 VC D18, and/or Subject Proof on VP D34.

The subject device (C1) may include an input for the subject (A1) to control the subject device (C1), a display to show the subject data such as the connection QR code (D1) and the USCIS I-9 fair witness VC (D9). The subject device (C1) may have at least one processor, memory (e.g., RAM), and/or a Network Interface, as described above. It may run an Executable Algorithm configured to perform operations that help distill information for use in generating a credential and help the subject (A1) participate in an event. An event may include a fair witness ceremony, but is not necessarily limited to this, and may include other events where unique digital information is captured, stored, and/or associated with the event, consistent with disclosed embodiments. Additionally, the subject device (C1) may have a Credential Datastore to store credentials (D9) and a store of Cryptographic Metadata to help retrieve cryptographic material from the Keystore. Finally, the subject device (C1) may use or require a trusted platform module (TPM) (2016) to compute cryptographic operations like verifying the fair witness VC Proof (D10) and creating and signing the verifiable presentation (VP) (D18) of the USCIS I-9 fair witness VC.

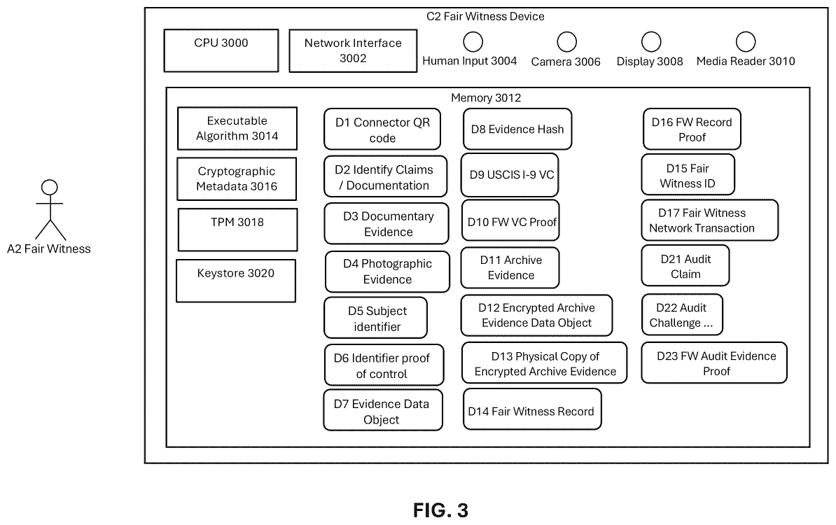

FIG. 3 depicts a schematic diagram illustrating a fair witness device and data objects related to the fair witness for operating a system and method for identity verification and assurance, according to one embodiment. Exemplary fair witness device C2 may include at least one processor (e.g., CPU 3000), network interface 3002, human input 3004 (e.g., a human input device), camera 3006, display 3008, media reader 3010, and a memory 3012, which may include one or more separate memory components. Fair witness device C2 may receive (e.g., via network interface 3002, human input 3004, camera 3006, and/or media reader 3010), and/or memory 3012 may store, data such as executable algorithm 3014, cryptographic metadata 3016, TPM 3018, keystore 3020, connection QR code D1, identity claims/documentation D2, documentary evidence D3, photographic evidence D4, subject identifier D5, identifier proof of control D6, evidence data object D7, evidence hash D8, USCIS I-9 VC D9, FW VC Proof D10, archive evidence D11, encrypted archive evidence data object D12, physical copy of encrypted archive evidence D13, fair witness record D14, fair witness ID D15, FW record proof D16, fair witness network transaction D17, audit claim D21, audit challenge evidence D22, and/or FW audit evidence proof D23.

With reference to FIG. 3, the fair witness device (C2) may be controlled by the fair witness (A2) who uses it to manage the fair witness ceremonies. The fair witness device (C2) may establish data transfer connections with the one or more subject devices (C1), allowing for the transmission of information to the fair witness device, such as the subject identifiers (D5) and associated identifier proofs of control (D6).

This information may be used in a process of producing an evidence data object (D7) and/or actions taken at an event, including the actions of creating the USCIS I-9 verifiable credential (D9), creating a fair witness record (D14), and/or registering that record in a register and/or at a node or network (e.g., Step 107 in FIG. 1).

The fair witness device (C2) may produce digital evidence information. For example, fair witness device (C2) may scan identity documentation (D2) to produce documentary evidence (D3) and/or may take photos to produce photographic evidence (D4). The evidence (D3, D4) may be bundled into an evidence data object (D7), and the bundle of evidence is then hashed (D8). The fair witness device (C2) may create and sign fair witness credentials, such as the USCIS I-9 fair witness VCs (D9), and produce the fair witness records (D14) which are published (e.g., by the fair witness device) to the fair witness network (C4), such as in the form of fair witness network transactions (D17). A fair witness record may correspond to (e.g., include, point to, and/or identify) the digital fair witness credential and/or the evidence (e.g., evidence bundle).

The fair witness device (C2) may produce archive evidence (D11), encrypt it as encrypted archive evidence (D12), and store this in the offline archive (C3). By cryptographically hashing a particular set of information bundled at a particular time and generating a credential, it is possible to establish that a claimed set of information is the same as the original information used to produce the cryptographic hash, ensuring that recipients of said information can independently verify the information is authentic and not been tampered with.

Registering a record of an event (D14) on a fair witness network (e.g., C4) via a fair witness node (e.g., C4a, C4b, C4c, C4d), enables a recipient (e.g., any recipient) of that credential (e.g., A3) to verify its provenance and legitimate authorship by a registered fair witness, without directly contacting an originating witness or device, avoiding the so called “phone home” problem and associated privacy harms.

Encrypting the information provided by the subject (D3) in an evidence data object (D7), secures the evidence bundle at rest so that even if an attacker were to gain access to the digital archive (D13), the evidence is useless without also compromising the fair witness's personal key store (3020) to access the key to decrypt.

The fair witness device (C2) may also be used to respond to audits. The fair witness device (C2) may receive and verify an audit claim (D21), such as a digitized audit request associated with a fair witness credential, then retrieve the archive evidence (D11) from the offline archive (C3) and use this to construct and present audit challenge evidence (D22) to the audit device (C8).

The fair witness device (C2) may use or require CPU, RAM, and a Network Interface. It may run an Executable Algorithm designed to process digital information related to fair witness ceremonies, which may be run by fair witness (A2). The fair witness device (C2) may have a human input device or mechanism that enables the fair witness (A2) to control the fair witness device (C2) and a display to provide feedback to the fair witness (A2). The fair witness device (C2) may also use or require a camera so the fair witness (A2) can take photographic evidence (D4) as part of an event. The fair witness device (C2) may have a media reader for the purposes of reading the physical copy of the encrypted archive evidence (D13). Finally, the fair witness device (C2) may have a keystore 3020 for storing cryptographic material and a trusted platform module (TPM) for performing cryptographic operations.

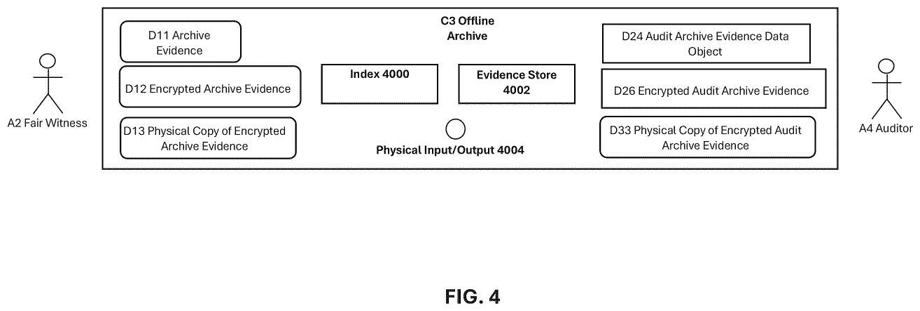

FIG. 4 depicts a schematic diagram illustrating an offline archive and data objects related to the offline archive for operating a system and method for identity verification and assurance, according to one embodiment. Exemplary offline archive C3 may include index 4000, evidence store 4002, and physical input/output 4004 (e.g., for receiving and transmitting data). Exemplary offline archive C3 may also be configured to receive and/or may store archive evidence D11, encrypted archive evidence D12, physical copy of encrypted archive evidence D13, audit archive evidence data object D24, encrypted audit archive evidence D26, and physical copy of encrypted audit archive evidence D33.

With reference to FIG. 4, both the fair witness (A2) and the auditor (A4) may control separate offline archives (C3). The fair witness (A2) may use the archive (C3) to store a physical copy of encrypted archive evidence (D13). The physical copy of encrypted archive evidence (D13) may contain encrypted archive evidence (D12), which contains archive evidence (D11). The archive evidence (D11) may be the evidence captured by the fair witness during execution of the fair witness protocol for a particular fair witness credential, e.g., the USCIS I-9 fair witness VCs (D9), that the fair witness (A2) issues. The auditor (A4) may use their archive (C3) to store a physical copy of encrypted audit archive evidence (D33). The physical copy of encrypted audit archive evidence (D33) may contain encrypted audit archive evidence (D26), which contains audit archive evidence data object (D24). The audit archive evidence data object (D24) may be the evidence captured by the fair witness while auditing a fair witness credential. The offline archive (C3) may use or require an index into an evidence store, a physical input, and/or a physical output in order to retrieve specific physical copies of encrypted archive evidence (D13).

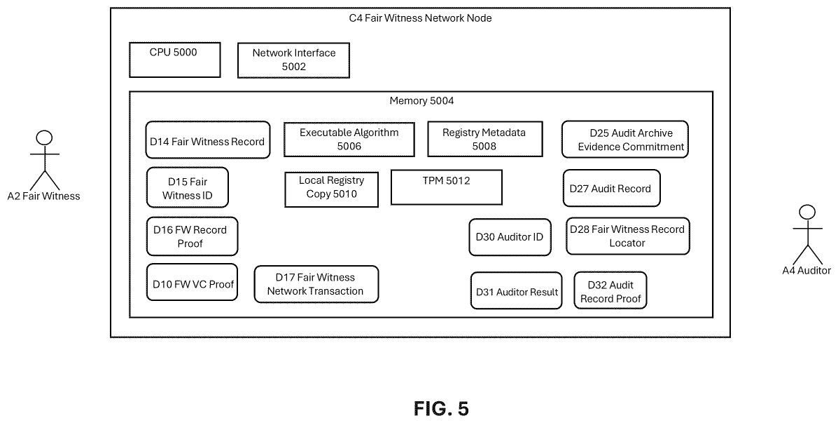

FIG. 5 depicts a schematic diagram illustrating a fair witness network node and data objects related to the fair witness network node for operating a system and method for identity verification and assurance, according to one embodiment. A fair witness network node (e.g., C4a, C4b, C4c, C4d) may include at least one processor (e.g., CPU 5000), network interface 5002, and a memory 5004, which may include one or more separate memory components. A fair witness network node (e.g., C4a, C4b, C4c, C4d) may receive (e.g., via network interface 5002), and/or memory 5004 may store, data such as executable algorithm 5006, registry metadata 5008, local registry copy 5010, TPM 5012, FW VC Proof D10, fair witness record D14, fair witness ID D15, FW record proof D16, fair witness network transaction D17, audit archive evidence commitment D25, audit record D27, fair witness record locator D28, auditor ID D30, audit result D31, and/or audit record proof D32.

With reference to FIG. 5, the fair witness network nodes (e.g., C4a, C4b, C4c, C4d) may be, maintain, or include a public append-only data store that is used to publish the fair witness records (D14) and/or audit records (D27), such as in the form of the fair witness network transactions (D17). The fair witness network node (e.g., C4a, C4b, C4c, C4d) may participate with other nodes to maintain consensus around the state of the network. For example, the network nodes may maintain a blockchain of network transactions (e.g., D17). The append-only data stores may be a data storage that only allows new data to be added to the end of existing data. It is appreciated that using an append-only data store improves reliability of data authenticity by preventing changes to data (e.g., network transactions) that are maintained across multiple network nodes.

The fair witness network (C4) may include any number of fair witness nodes, such as, merely by way of example, four different fair witness nodes (e.g., C4a, C4b, C4c, C4d). Each may have identical functionality and be configured for secure operation by their owners.

A fair witness network node (e.g., C4a, C4b, C4c, C4d) may use a CPU, RAM (or other type of memory), and a Network Interface. It may run an Executable Algorithm that enables it to participate with other nodes to maintain the consensus of the state of the fair witness network. It may use or require a copy of the network state, the registry copy, and/or additional registry metadata. Additionally, the fair witness network node (e.g., C4a, C4b, C4c, C4d) may use or require a TPM to compute one or more cryptographic operations necessary to verify the fair witness network transactions (D17).

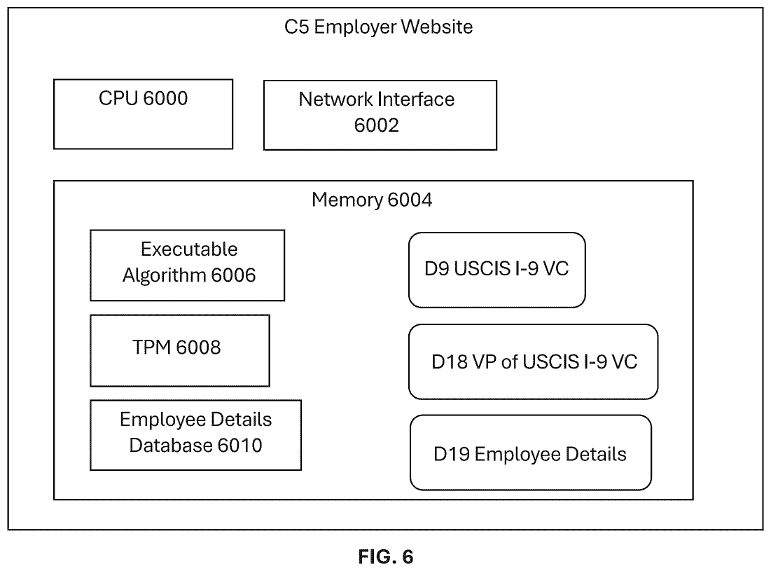

FIG. 6 depicts a schematic diagram illustrating an employer website and data objects related to the employer website for operating a system and method for identity verification and assurance, according to one embodiment. Exemplary employer website device C5 may include at least one processor (e.g., CPU 6000), network interface 6002, and a memory 6004, which may include one or more separate memory components. Employer website device C5 may receive (e.g., via network interface 6002), and/or memory 6004 may store, data such as executable algorithm 6006, TPM 6008, employee details database 6010, USCIS I-9 VC D9, VP of USCIS I-9 VC D18, and employee details D19.

With reference to FIG. 6, the employer website (C5) may manage remote onboarding of the subject (A1), requesting the subject (A1) present the USCIS I-9 fair witness VC (D9). The employee website may use a confirming device (C9) to perform verification and validation of the verifiable presentation (D18). The employee details (D19) may be retrieved from the USCIS I-9 fair witness VC (D9) and stored in the on-site check in system (C6).

The employer website (C5) may use or require CPU, RAM, and a Network Interface. It may run an Executable Algorithm that requests a confirming device (C9) to provide confirmation of received of USCIS I-9 fair witness VC from prospective employees. Additionally, the employer website (C5) may manage a database of employee details for those employees that have successfully completed the USCIS I-9 checks.

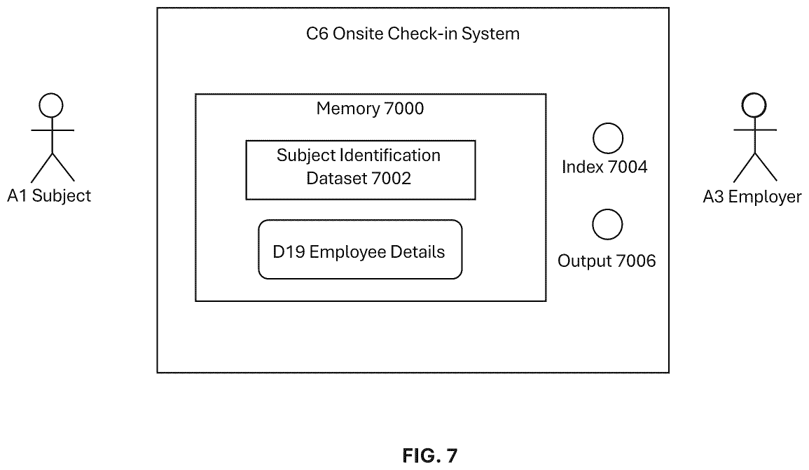

FIG. 7 depicts a schematic diagram illustrating an onsite check-in system (employer system) and data objects related to the onsite check-in system for operating a system and method for identity verification and assurance, according to one embodiment. Exemplary on-site check-in system C6 may include a memory 7000, which may include one or more separate memory components, index 7004 and output 7006. On-site check-in system C6 may receive and/or memory 7000 may store data such as subject identification dataset 7002 and/or employee details D19.

With reference to FIG. 7, the on-site check in system (C6) may store the employee details (D19) for employees (A1) that have completed remote onboarding. The employer (A3) may check the subject (A1) against the employee details (D19) to ensure that the employer (A3) is the same person shown in the employee details (D19).

The onsite check-in system (C6) may use or require an indexed subject identification dataset so that employers (A3) can check subjects (A1) against the dataset. It may also contain an output for providing the photograph of employees (A1) that the employer (A3) can check against.

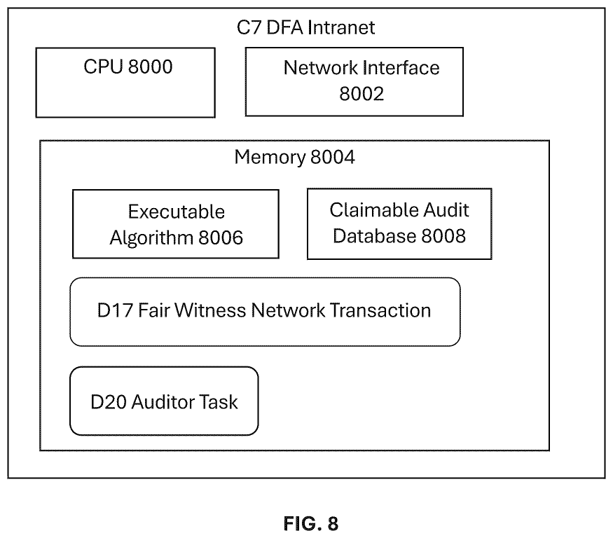

FIG. 8 depicts a schematic diagram illustrating a Digital Fiduciary Association (DFA) intranet and data objects related to the DFA intranet for operating a system and method for identity verification and assurance, according to one embodiment. Exemplary DFA intranet C7 may include at least one processor (e.g., CPU 8000), network interface 8002, and a memory 8004, which may include one or more separate memory components. DFA intranet C7 may receive (e.g., via network interface 8002), and/or memory 8004 may store data such as executable algorithm 8006, claimable audit database 8008, fair witness network transaction D17, and/or auditor task D20.

With reference to FIG. 8, the DFA intranet (C7) may manage accreditation of the fair witnesses (A2) and auditors (A4), registering fair witness IDs (D15) and auditor IDs (D30). The DFA intranet (C7) may also monitor the fair witness network transaction (D17) using the fair witness network node (e.g., C4a, C4b, C4c, C4d) for audit tasks (D20) which it assigns to the auditing entities (A4).

The DFA intranet (C7) may use or require CPU, RAM, and a Network Interface. It may run an Executable Algorithm that works to assign audit tasks (D20) to auditors (A4) based on transactions on the digital fiduciary network. The DFA intranet (C7) may manage a claimable audit database containing the audit tasks (D20) that are available to be claimed.

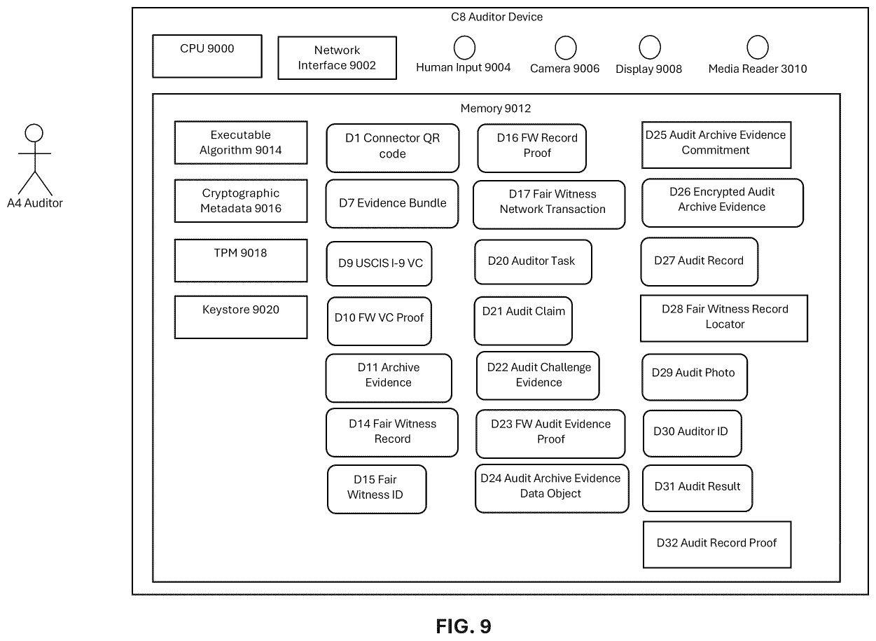

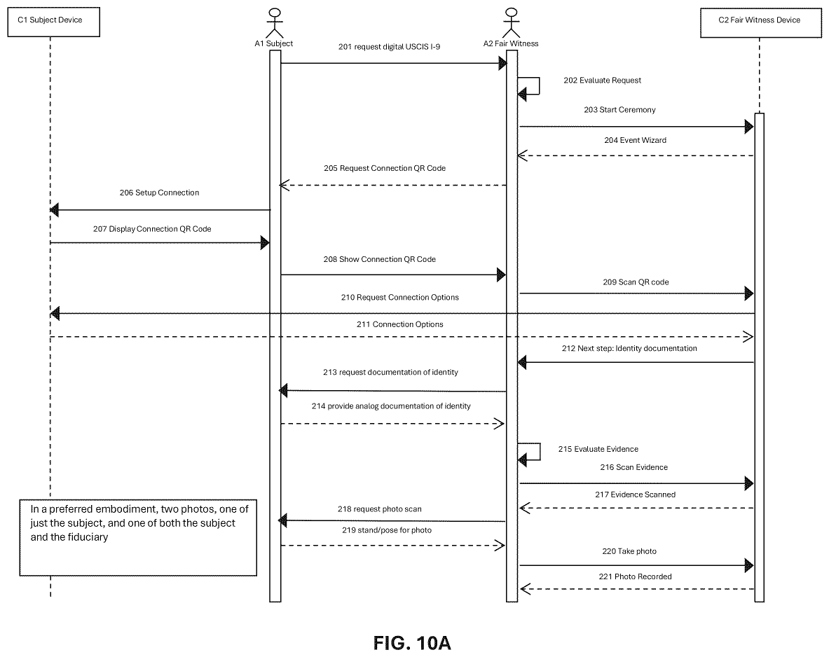

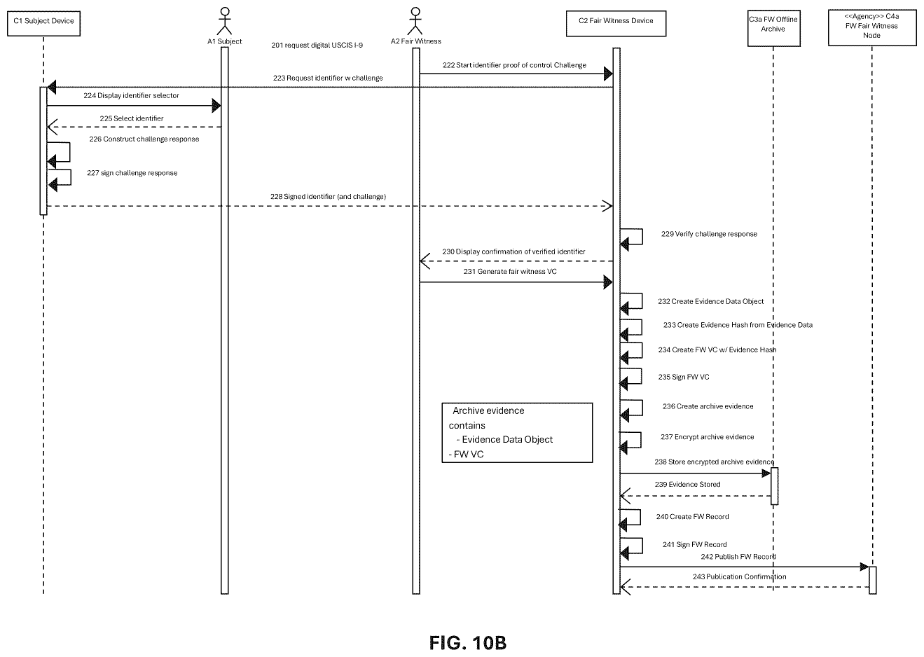

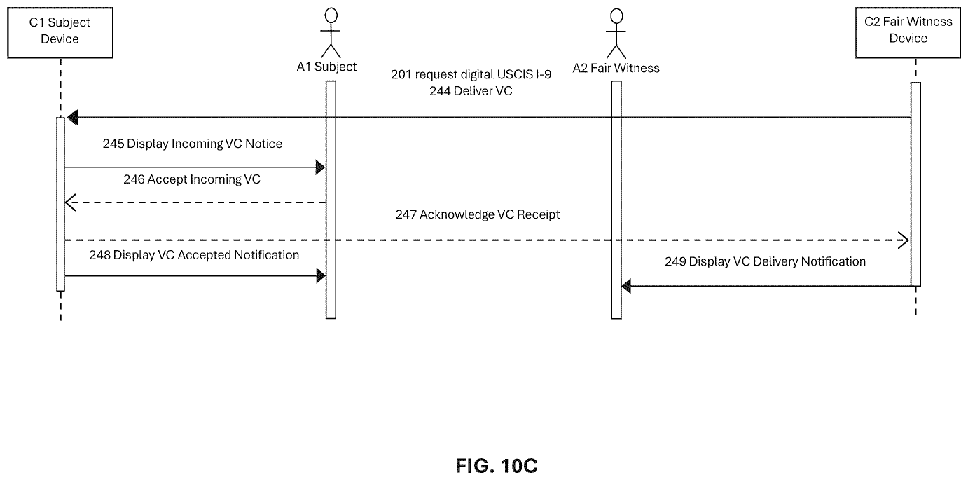

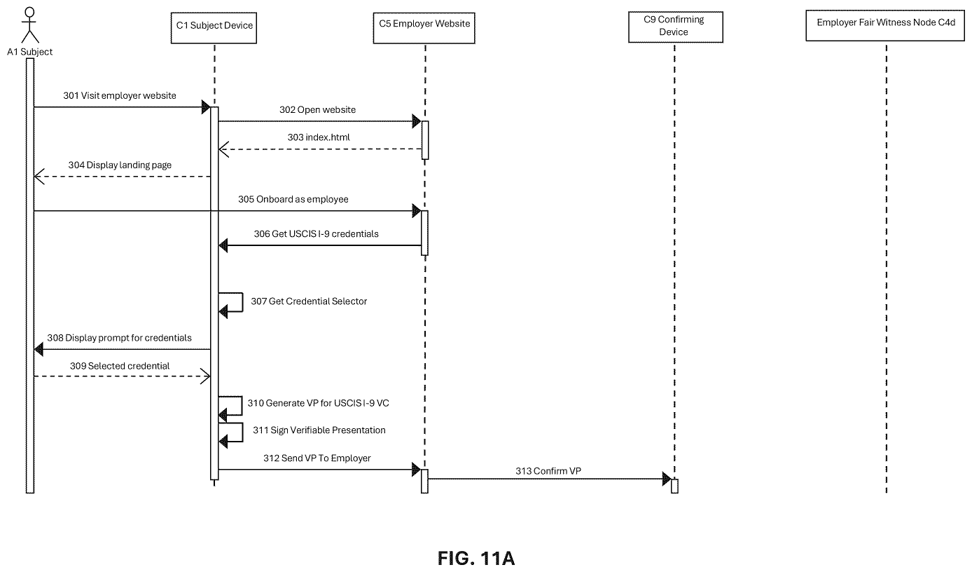

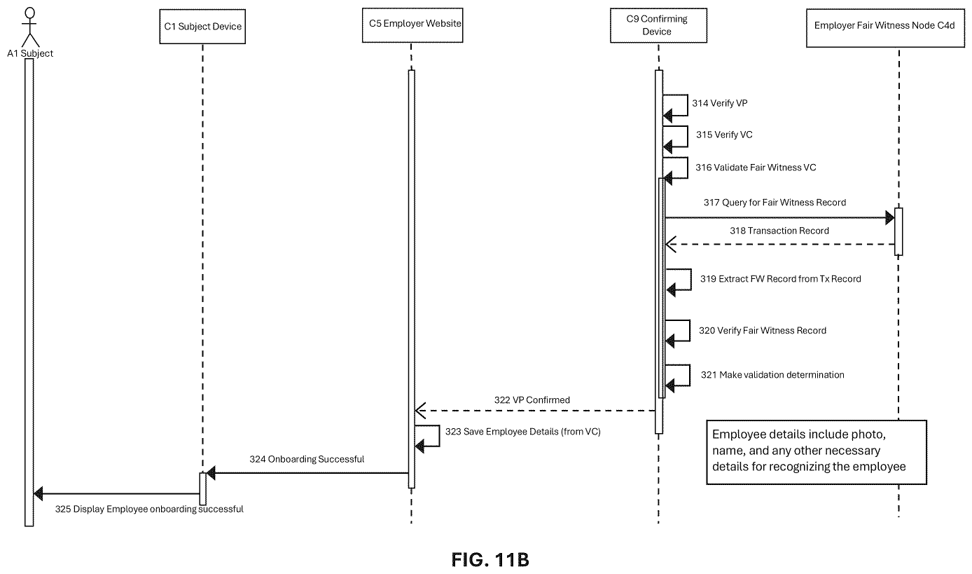

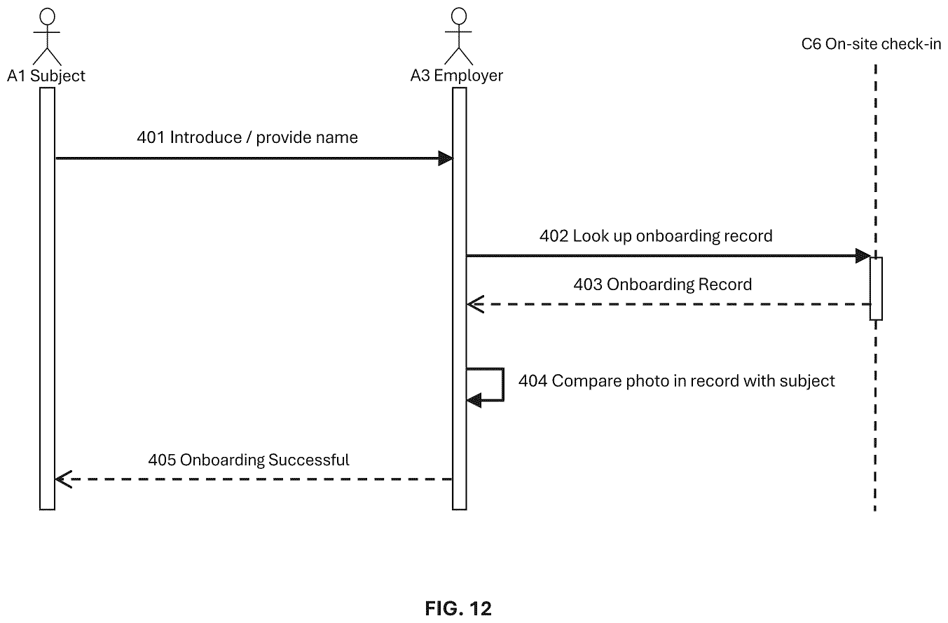

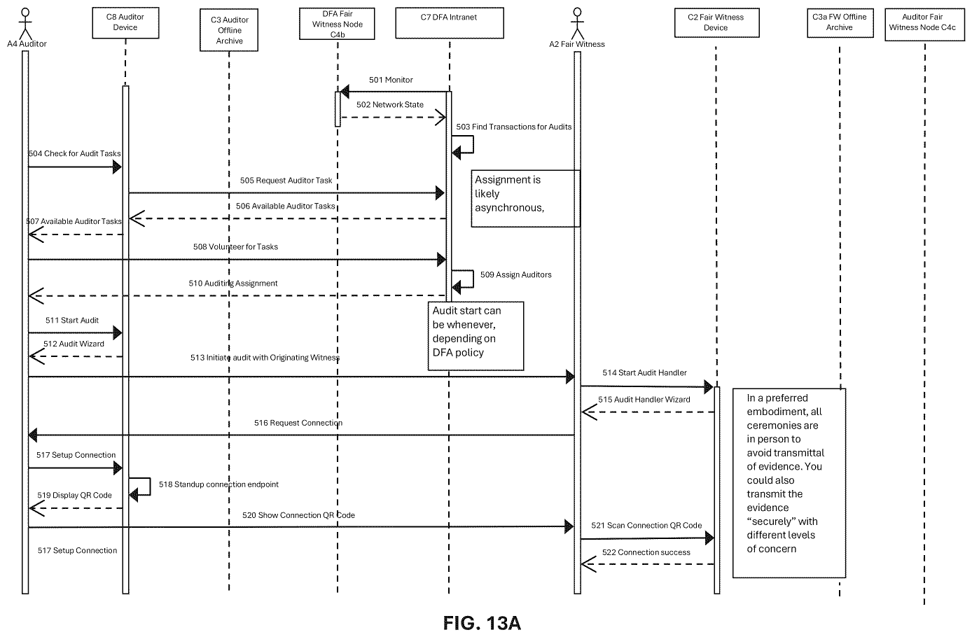

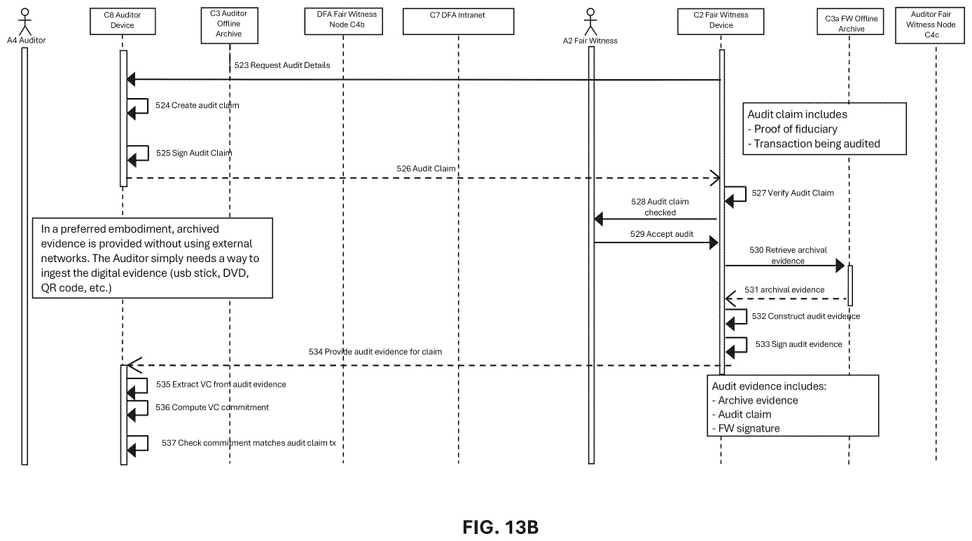

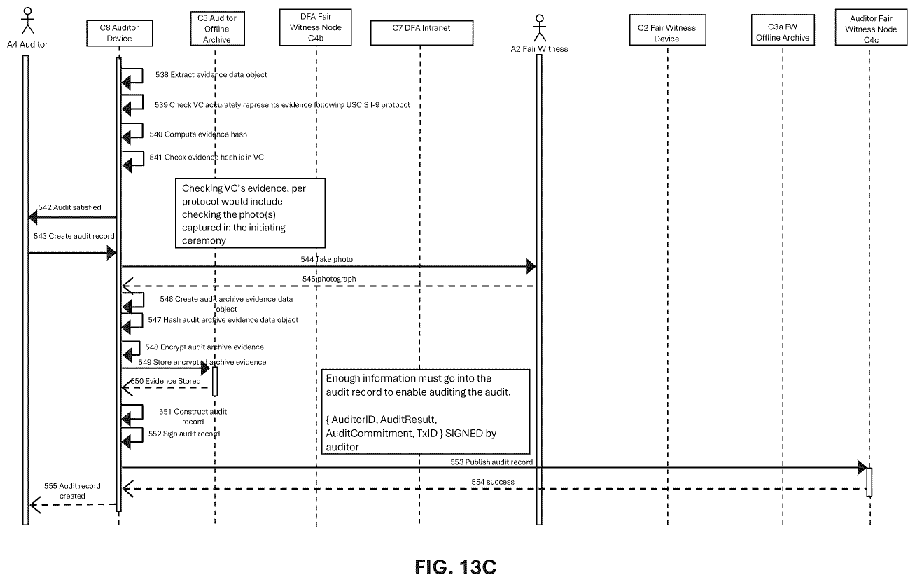

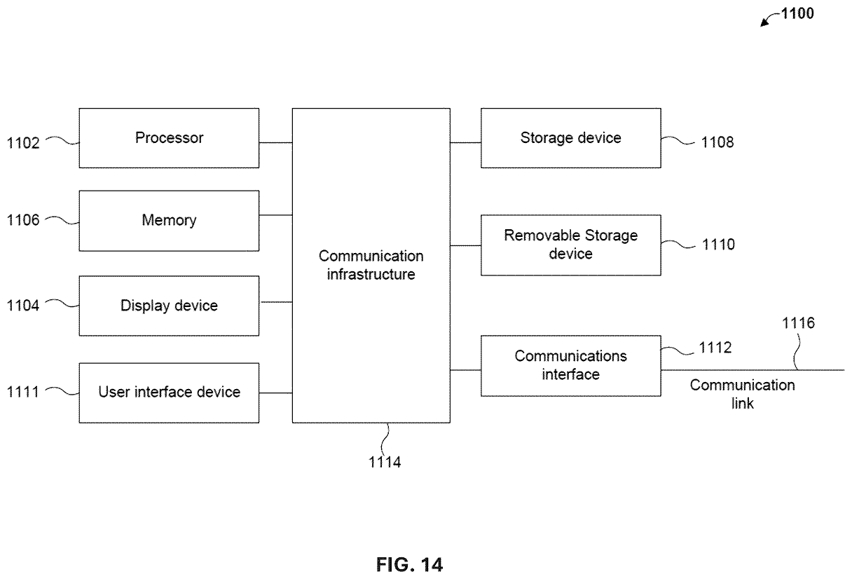

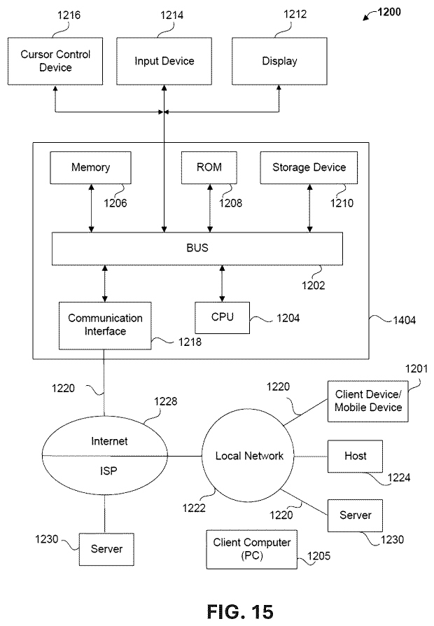

FIG. 9 depicts a schematic diagram illustrating an auditor device and data objects related to the auditor device for operating a system and method for identity verification and assurance, according to one embodiment. Exemplary auditor device C8 may include at least one processor (e.g., CPU 9000), network interface 9002, human input 9004 (e.g., a human input device), camera 9006, display 9008, media reader 9010, and memory 9012, which may include one or more separate memory components. Auditor device C8 may receive (e.g., via network interface 9002, human input 9004, camera 9006, and/or media reader 9010), and/or memory 9012 may store, data such as executable algorithm 9014, cryptographic metadata 9016, TPM 9018, keystore 9020, connection QR code D1, evidence data object D7, USCIS I-9 VC D9, FW VC Proof D10, fair witness record D14, fair witness ID D15, FW record proof D16, fair witness network transaction D17, auditor task D20, audit claim D21, audit challenge evidence D22, FW audit evidence proof D23, audit archive evidence data object D24, audit archive evidence commitment D25, encrypted audit archive evidence D26, audit record D27, fair witness record locator D28, audit photo D29, auditor ID D30, audit result D31, and/or audit record proof D32.

With reference to FIG. 9, the auditor device (C8) may be controlled by the auditor(A4), who uses it to collect audit tasks (D20) from the DFA intranet (C7). Then, the auditor device (C8) may establish connections with the fair witness devices (C2), present the audit claims (D21), and receive and verify the audit challenge evidence (D22) against the fair witness record (D14) assigned by the audit task (D20). Following this, the audit device (C8) may construct an audit record (D27) and publish this in a fair witness network transaction (D17). Additionally, the audit device (C8) may create audit archive evidence commitment (D25) for the audit, encrypt this evidence as encrypted audit archive evidence (D26), and store it in their offline archive (C3).

The auditor device (C8) may use or require CPU, RAM, and a Network Interface. It may run an Executable Algorithm that helps to coordinate the auditing entities (A4) confirm/audit workflow. The auditor device (C8) may contain a human input used by the auditor (A4) to control the auditor device (C8) and a display to provide feedback to the auditor (A4). The auditor device (C8) may use or require a camera in order to record photographic evidence of the audit and a media reader for the audit archive evidence. The auditor device (C8) may manage cryptographic metadata necessary to retrieve cryptographic material from a keystore and a TPM to perform cryptographic operations.

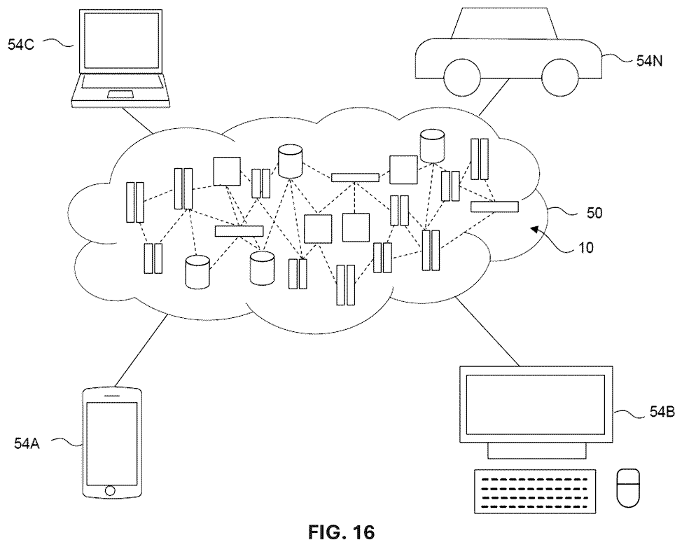

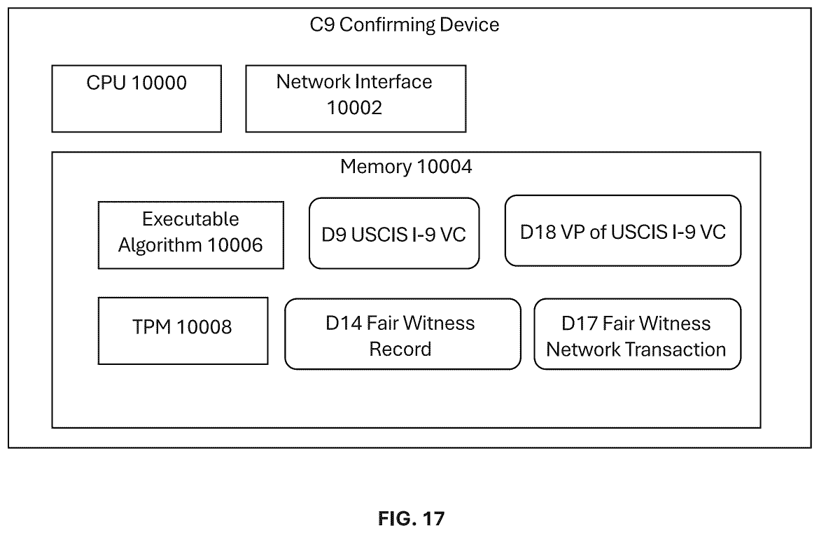

FIG. 17 depicts a schematic diagram illustrating a confirming device and data objects related to the device for operating a system and method for identity verification and assurance, according to one embodiment. Exemplary confirming device (C9) may include at least one processor (e.g., CPU 10000), network interface 10002 and a memory 10004, which may include one or more separate memory components. Auditor device C8 may receive (e.g., via network interface 10002), and/or memory 10004 may store data such as executable algorithm 10006, TPM 10008, keystore 9020, USCIS I-9 VC D9, fair witness record D14, fair witness network transaction D17 and/or VP of USCIS I-9 VC D18.

With reference to FIG. 17, the confirming device may be controlled by the employer website (C5), that uses the device to verify and validate a presentation of a fair witness credential (e.g. D9). The USCIS I-9 fair witness VC proof (D10) may be verified using cryptographic methods, which may be defined by the cryptosuite used by that credential. Then an associated fair witness record (D14) is retrieved from the fair witness network (C4), which may involve communicating with a local fair witness network node. The fair witness record is used by the confirming device to validate the USCIS I-9 VC (D9) is a fair witness credential.

The confirming device (C9) may use CPU, RAM and a network interface. It may run an Executable Algorithm in order to perform verification and validation of presentations. Additionally, the confirming device (C9) may use a TPM to execute cryptographic operations necessary to verify cryptographic signatures.

FIGS. 10A to 13C include four different flowcharts: the fair witness event, onboarding, on-site validation, and audit. These may have a typical flow in time, but they may be asynchronous and only ordered by dependencies. For example, a credential for a subject needs to be present before it is presented, or the subject needs to be in the database before on-site validation, etc. However, each flow may be independent from the others and may happen more than once. For example, a subject may obtain multiple fair witness credentials from different fair witness providers before doing any onboarding.

FIGS. 10A to 10C depict a flowchart of the steps 200 for requesting, by a data subject, a digital U.S. Citizenship and Immigration Services (USCIS) I-9 fair witness VC, which is processed by a fair witness device and a fair witness network, resulting in a newly issued VC and a network registration, according to one embodiment. Once the data subject provides evidence to satisfy the fair witness protocol, the fair witness may issue a fair witness credential to the data subject and register an attestation of this issuance on a fair witness network. The flowcharts in FIGS. 10A to 10C continue sequentially; however C3a and C4a only play a role in 10B and do not appear in 10A or 10C. The sequence diagram in FIGS. 10A to 10C walks through the creation and issuance of a USCIS I-9 fair witness VC (D9) after satisfying the USCIS I-9 protocols or requirements, which indicate right to work verification.

With reference to FIGS. 1 to 3, and 10A, first, the subject (A1) meets in-person with the fair witness (A2) and requests a digital USCIS I-9 fair witness VC (Step 201). The fair witness (A2) evaluates this request, checking whether this request is a service they can provide (Step 202). Then, if this request is a service they can provide, the fair witness (A2) starts the fair witness event on their fair witness device (C2) (Step 203). The fair witness device (C2) responds with an event wizard for the USCIS I-9 fair witness event (Step 204).

Following the step of receiving the event wizard, the fair witness (A2) asks the subject (A1) for a connection QR code (D1) to initiate a connection between the fair witness device (C2) and the subject device (C1) (Step 205). The subject (A1) requests their subject device (C1) to set up a connection (Step 206), and the subject device (C1) responds by displaying a connection QR code (D1) (Step 207). Then, the subject (A1) shows the connection QR code (D1) to the fair witness (A2) (Step 208). The fair witness device (C2) may scan the connection QR code (D1) (Step 209), thereby reading a digital identifier (e.g., URI, URL, etc.) from the connection QR code (D1), which it may use to establish a connection with the subject device (C1) and/or request connection options from the subject device (C1) (Step 210). The subject device (C1) responds with a set of connection options for how the fair witness device (C2) can interact with the subject's device (C1) (Step 211).

After receiving the connection options, the fair witness device (C2) updates the event wizard to display to the fair witness (A2) that the next step is evaluating the identity documentations necessary for the USCIS I-9 protocol (Step 212). The fair witness (A2) requests the subject (A1) to provide the necessary documentation of identity (Step 213), and the subject (A1) responds by providing the necessary analog documentation of identity, such as a passport or driver's license (D2) (Step 214). The fair witness (A2) evaluates this evidence (Step 215), then scans it using their fair witness device (C2) producing documentary evidence (D3) (Step 216). Once scanned, the fair witness device (C2) notifies this documentary evidence (D3) to the fair witness (A2) (Step 217). The fair witness (A2) then asks the subject (A1) for a photograph (Step 218), and the subject (A1) stands and poses for the photo (Step 219). The fair witness (A2) takes a photograph of the subject (A1) using their fair witness device (C2) (Step 220), which then notifies them that the photographic evidence (D4) has been successfully recorded (Step 221). In some embodiments, the fair witness (A2) takes two photos, one of just the subject (A1) to be included in the USCIS I-9 fair witness VC (D9) and another of both the subject (A1) and themselves (A2) to be included in the archive evidence (D11).

With reference to FIGS. 1 to 5, and 10B, once all the evidence including the documentary evidence (D3) and the photographic evidence (D4) has been collected and evaluated, the fair witness (A2) requests that their fair witness device (C2) start an identifier proof of control challenge with the subject device (C1) (Step 222). The fair witness device (C2) uses the connection to the subject device (C1) to request an identifier with a specific challenge (Step 223). In this case, the “challenge” may include a specific string used for preventing replay attacks. An example of requesting an identifier with a challenge may include a JavaScript Object Notation (JSON) object based on the Verifiable Presentation Request (VPR) standard. The following JSON may be an example of requesting an identifier with a challenge.

{“query”: [{“type”: “DIDAuthentication”, “acceptedMethods”: [{“method”: “example”}]

}], “challenge”: “99612b24-63d9-11ea-b99f-4f66f3e4f81a”, “domain”: “example.com”}

The subject would reply with a Decentralized Identifier (DID) and a signature over the challenge string and domain in this case.

The subject device (C1) displays this request to the subject (A1) using an identifier selector and asks them to select an identifier (Step 224). For example, in the above example, the VPR's identifier selector may request an identifier with a DID method of “example”. The subject (A1) selects an identifier (D5), which may include creating a new one (Step 225). With Decentralized Identifiers (DID), the identifier subject may create new ones at any time. During a request of this kind, the user may be prompted to either use an existing identifier or create a new one. The subject device (C1) uses this identifier (D5) to construct an identifier proof of control (D6) as a challenge response (Step 226) which it then signs (Step 227). The subject device (C1) then sends this signed identifier (D5) and identifier proof of control (challenge response, D6) to the fair witness device (C2) (Step 228). The fair witness device (C2) verifies the identifier proof of control (challenge response, D6) (Step 229) and displays a confirmation to the fair witness (A2) that the verified identifier (D5) has been received from the subject (A1) (Step 230).

The fair witness (A2) then instructs their fair witness device (C2) to generate a USCIS I-9 fair witness VC (D9) (Step 231). The fair witness device (C2) bundles the collected evidence together as the evidence data object (e.g., evidence of identity) (D7), which includes the documentary evidence (D3) and the photographic evidence (D4) (Step 232) and creates an evidence hash (D8) of this evidence data object (D7) (Step 233). Then, the fair witness device (C2) creates the USCIS I-9 fair witness VC (D9) which includes the evidence hash (D8) (Step 234) and signs this credential (Step 235). Following this, the fair witness device (C2) creates an archive evidence data object (D11) containing the USCIS I-9 fair witness VC (D9) and the evidence data object (D7) (Step 236) and then encrypts this archive evidence data object (D12) (Step 237). The encrypted archive evidence (D12) may be stored in an offline archive (C3) (Step 238, Step 239). The fair witness device (C2) then creates a fair witness record (D14) for the USCIS I-9 fair witness VC (D9) (Step 240) and signs this record (Step 241). The fair witness record (D14) may include the accountable identifier of the fair witness (fair witness ID, D15), the proof from the fair witness VC (fair witness VC proof, D10) they are generating, and/or a signature over this data from the fair witness (fair witness record proof, D16). The fair witness record (D14) is registered and/or published in a fair witness network transaction (D17) on the fair witness network (C4) through the FW Fair Witness Network Node (C4a) (Step 242), which confirms registration and publication (Step 243). Registering and/or publishing the fair witness record on the fair witness network may include cryptographically associating (e.g., through hashing, putting “on-blockchain”, adding to a distributed digital ledger, etc.) the fair witness record with a signed digital fair witness credential and/or an evidence data object, consistent with disclosed embodiments.

With reference to FIGS. 1 to 3, and 10C, once the fair witness record (D14) has been successfully registered, the fair witness device (C2) delivers the USCIS I-9 fair witness VC (D9) to the subject device (C1) (Step 244). The subject device (C1) displays to the subject (A1) an incoming VC notification (Step 245), and the subject (A1) instructs their subject device (C1) to accept this VC (D9) (Step 246). The subject device (C1) then notifies the fair witness device (C2) that the USCIS I-9 fair witness VC (D9) has been received (Step 247) and displays a notification to the subject (A1) that the USCIS I-9 fair witness VC (D9) has been accepted (Step 248). The fair witness device (C2) displays a notification to the fair witness (A2) that the USCIS I-9 fair witness VC (D9) has been successfully delivered (Step 249), which completes the fair witness event.

FIGS. 11A and 11B depict a flowchart of the steps 300 for digitally onboarding, by the data subject, with an employer through an employer website using the digital USCIS I-9 credential, according to one embodiment. The flowcharts in FIGS. 11A and 11B continue sequentially. The employer website may verify that this USCIS I-9 credential was issued by a fair witness and onboard the employee pending in-person photographic verification. With reference to FIGS. 1, 2, 17, 10A-10C, and 11A, the subject (A1) uses the USCIS I-9 fair witness VC (D9) they received through the fair witness event described in the steps 200 (FIGS. 10A to 10C) to onboard with an employer (A3) remotely through the employer website (C5). Specifically, first, the subject (A1) uses their subject device (C1) to visit the employer's website (C5) (Step 301). The subjects device (C1) opens the employer website (C5) (Step 302), and the website (C5) returns an index.html page (Step 303) which the subjects device (C1) displays to the subject (A1) showing the employer's landing page (Step 304).

The subject (A1) then requests through the employer website (C5) to onboard as an employee (Step 305), and the employer website (C5) requests that the subject device (C1) provide the necessary USCIS I-9 fair witness VC (Step 306). The subject device (C1) runs a credential selector to identify possible credentials it could use to respond to the request of the employer website (C5) (Step 307) and displays the options of the credential selector to the subject (A1) (Step 308). The request from the employer website (C5) may be a JSON request sent from the verifier identifying which credentials they accept. The subject (A1) then may use that information to see if they have credentials that match this request. These options of the credential selector may then be displayed to the subject (A1) so that the subject (A1) can select which credential to use. The subject (A1) uses these options to select the USCIS I-9 fair witness VC (D9) (Step 309). The subject device (C1) then creates and signs a Verifiable Presentation (VP) (D18) of this USCIS I-9 fair witness CV (D9) (Step 310), signs the VP (Step 311) creating a Subject Proof on VP (D34), and sends the VP (D18) to the employer website (C5) (Step 312). The employer website requests confirmation of the VP from the confirming device (C9) (Step 313).

On receiving the VP (D18), with reference to FIGS. 1, 5, 6, 17, and 11B, the confirming device (C9) first verifies the Subject Proof on the VP (D34) and then verifies the proof (D10) on the USCIS I-9 fair witness VC (D9) (Steps 314, 315) (e.g., determining a verification status of the proof) before proceeding to validate the USCIS I-9 fair witness VC (D9) is a fair witness VC (Step 316). To do this, the confirming device (C9) queries an employer fair witness network node (e.g., C4d) for the corresponding fair witness record (D14) for the USCIS I-9 fair witness VC (D9) (Step 317), and the employer fair witness network node (e.g., C4d) responds with the record of a fair witness network transaction (D17) (Step 318). The confirming device (C9) extracts the fair witness record (D14) from the fair witness network transaction (D17) (Step 319), verifies the fair witness record proof (D16) on the fair witness record (D14) (Step 320), and makes a validation determination (e.g., based on verifying the fair witness record proof on the fair witness record) (Step 321). The confirming device (C9) returns the result of confirming the VP to the employer website (C5) (Step 322). The employer website (C5) then records the employee details (D19) such as a photograph, name, and any other necessary details, from the USCIS I-9 fair witness VC (D9) in their internal system (C6) for an in-person verification at a later stage (Step 323). Then, the employer website (C5) notifies the subject device (C1) that onboarding has been successfully completed (Step 324), which the subject device (C1) displays this to the subject (A1) (Step 325) ending the remote onboarding flow.

FIG. 12 depicts a flowchart of the steps 400 for in-person onboarding where the employer meets in person with the subject who has remotely onboarded and check the subject's identity (e.g., name and face) against their internal systems using information collected in the remote onboarding described above with reference to FIGS. 11A and 11B, according to one embodiment. With reference to FIGS. 1, 7, and 12, following a successful remote onboarding as shown in the steps 300 shown in FIGS. 11A and 11B, the subject (A1) introduces themselves to their employer (A3) and provides their name (Step 401). The employer (A3) uses the subject's name to search their on-site check in system (C6) for an onboarding record (Step 402). The on-site check in system (C6) responds with an onboarding record containing employee details (D19) including a photograph of the subject (A1) (Step 403). The employer (A3) compares the photograph in the employee details (D19) with the subject (A1) standing in front of them (Step 404). Once satisfied that the subject (A1) is the person represented by the employee details (D19), the employer (A3) notifies the subject (A1) that onboarding is complete (Step 405).

FIGS. 13A to 13C depicts a flowchart of the steps 500 for auditing, by a auditor, a fair witness record, according to one embodiment. The flowcharts in FIGS. 13A to 13C continue sequentially. In steps 500, the auditor confirms the fair witness record published in a fair witness network transaction to the fair witness network verifying that the USCIS I-9 fair witness VC they issued after evaluating evidence was an accurate representation of the evidence after following a specific protocol of USCIS I-9.

With reference to FIGS. 1, 3, 5, 8, 9, and 13A, the audit flow starts with the DFA intranet (C7) monitoring the fair witness network node (e.g., C4c) (Step 501). The fair witness network node (e.g., C4c,) responds with network state (Step 502) which the DFA intranet (C7) searches for fair witness network transactions (D17) to audit (Step 503). The DFA intranet (C7) is continuously monitoring the auditor fair witness network node (e.g., C4c) for fair witness network transactions (D17) to audit in this manner.

At some point, a auditor (A4) checks their audit device (C8) for audit tasks (D20) (Step 504), and the audit device (C8) sends a request to the DFA intranet (C7) asking for audit tasks (D20) (Step 505). The DFA intranet (C7) responds with a set of available audit tasks (D20) that the auditor (A4) could take on (Step 506), which the audit device (C8) displays to the auditor (A4) (Step 507). The auditor (A4) then selects an audit task (D20) and volunteers to take it on, using their auditor device (C8) (Step 508). The DFA intranet (C7) then assigns available tasks to auditors (A4) based on who has volunteered (Step 509) and notifies the auditor (A4) of their assigned audit task (D20) via the auditor device (C8) (Step 510). In some embodiments, the assignment of the tasks to the auditor (A4) may be asynchronous, perhaps daily. In some embodiments, audits may be triggered any time depending on Digital Fiduciary Association (DFA) policy.

Once assigned an audit task (D20), the auditor (A4) then requests that their audit device (C8) start the audit (Step 511), and the audit device (C8) responds with an audit wizard (Step 512). The auditor (A4) then reaches out to the originating fair witness (A2) associated with the audit task (D20) to initiate the audit with them (Step 513). In some embodiments, the audit process may be performed by visiting them in person. In other embodiments, the audit process may be performed digitally via the auditor device (C8) and the fair witness device (C2). The fair witness (A2) uses their fair witness device (C2) to start up the audit handler (Step 514). The fair witness device (C2) responds with an audit handler wizard requesting a connection with the auditor (A4) (Step 515), so the fair witness (A2) requests that the auditor (A4) provide them with a connection (Step 516). Then, the auditor (A4) requests that their auditor device (C8) set up a connection with the fair witness device (C2) (Step 517), and the auditor device (C8) stands up a connection endpoint (Step 518). The connection endpoint may be displayed to the auditor (A4) as a connection QR code (D1) (Step 519). The auditor (A4) shows this connection QR code (D1) to the fair witness (A2) via the auditor device (C8) (Step 520), and then the fair witness (A2) scans it using their fair witness device (C2) (Step 521). The fair witness device (C2) responds with a connection success notification (Step 522). In some preferred embodiments, all ceremonies may be in person to avoid transmittal of evidence. Alternatively, the evidence may be transmitted securely with different levels of concern.

With reference to FIGS. 1, 3, 4, 9, and 13B, following a successful connection, the fair witness device (C2) requests the audit details from the auditors device (C8) (Step 523). The auditor device (C8) creates an audit claim (D21) including a proof that they are a fiduciary and the details of the fair witness network transaction they are auditing (Step 524). The auditor device (C8) then signs this audit claim (D21) (Step 525) and sends it to the fair witness device (C2) (Step 526). The fair witness device (C2) verifies the audit claim (D21) (Step 527) and notifies the fair witness (A2) that the audit claim has been checked (Step 528).

The fair witness (A2) then accepts the audit (Step 529), and their fair witness device (C2) retrieves the necessary archival evidence (D11) for the fair witness network transaction (D17) being confirmed/audited from the offline archive (C3) (Step 530, Step 531). The fair witness device (C2) constructs the audit challenge evidence (D22) containing the archive evidence (D11) and the audit claim (D21) (Step 532) and signs the audit challenge evidence (D22) attaching the audit challenge evidence proof (D23) (Step 533). The fair witness device (C2) then shares the signed audit challenge evidence (D22) with the auditor device (C8) as evidence that the fair witness protocol was correctly followed (Step 534). The auditor device (C8) extracts the USCIS I-9 fair witness VC (D9) from the audit challenge evidence (D22) (Step 535), extracts the commitment to this VC (fair witness VC proof, D10) (Step 536), and checks that the commitment in the fair witness VC proof (D10) matches the commitment in the fair witness record (D14) identified by the audit claim (D21) they are auditing (Step 537).

With reference to FIGS. 1, 4, 5, 9, and 13C, once the auditor device (C8) confirms that the audit challenge evidence (D22) provided matches the audit claim (D21) they are auditing, they extract the evidence data object (D7) from the audit challenge evidence (D22) (Step 538) and check that the USCIS I-9 fair witness VC (D9) issued by the fair witness (A2) accurately represents the evidence data object (D7) following the USCIS I-9 protocol (Step 539). In some embodiments, checking the evidence of the USCIS I-9 fair witness VC (D9) per protocol may include checking the photo(s) captured in the initial event. The auditor device (C8) then computes the evidence hash (D8) of the evidence data object (D7) (Step 540) and checks that the evidence hash (D8) is included in the USCIS I-9 fair witness VC (D9) (Step 541).

Assuming the checks are satisfactory, the auditor device (C8) notifies the auditor (A4) that the audit has been satisfied (Step 542). The auditor (A4) then requests that the auditor device (C8) create an audit record (D27) (Step 543). First, the auditor (A4) uses their auditor device (C8) to take a photograph (D29) of the fair witness (A2) and themselves (A4) (Step 544, Step 545). Then, the auditor device (C8) creates the audit archive evidence data object (D24) (Step 546) which includes the audit photograph (D29) and the audit challenge evidence (D22) and hashes this evidence to produce an audit archive evidence commitment (D25) (Step 547). This audit archive evidence data object (D24) is then encrypted (Step 548), and the encrypted audit archive evidence (D26) is stored in the auditors offline archive (C3) (Step 549, Step 550).

After the encrypted audit archive evidence (D26) has been stored in the offline archive (C3), the auditor device (C8) constructs an audit record (D27) containing the audit archive evidence commitment (D25), a fair witness record locator (D28), the identifier of the auditor (auditor ID, D30), and the result of the audit (D31) (Step 551). The auditor device (C8) then signs this audit record (D27) adding an audit record proof (D32) (Step 552). Next, the auditor device (C8) publishes the audit record (D27) to the auditor fair witness network node (e.g., C4c) in the fair witness network transaction (D17) (Step 553) and is notified that this publication has been successful (Step 554). The auditor device (C8) then notifies the auditor (A4) that the audit record (D27) has been successfully created (Step 555), completing the audit.

The present system and method can be performed for identity verification and assurance without violating the privacy of the subject and disclosing unnecessary personal information. It has been practically impossible to know who is on the other side of a digital interaction without compromising privacy. For identity verification and assurance, conventional solutions require overcommunicating personal information unrelated to the question. Examples of failed identity assurance include: filing false tax returns, proof of unique personhood (e.g., voting, universal basic income), proof of personhood (e.g., spam defense, moderation, automation defense), restricted access (e.g., proprietary data, classified material, age-restricted sales), and credentialing (e.g., is the person presenting a credential the legitimate recipient of that credential?).

Despite numerous approaches for dealing with these technical problems, there is not yet a digital solution that satisfies the following requirements for identification under practical and technical constraints. The first requirement is individual control over the identifiers used. Individuals should be free to interact with, and as part of, any number of diverse associations, formal or informal. This requires the ability to represent oneself in different contexts without correlation to activity in other contexts.

The second requirement is technical verifiability without dependence on a centralized third party. Corporations sometimes play a role in mediating individual engagement with public services; however, that intermediation must be optional, without creating a dependence on private companies for interactions with the state (federal or local). The introduction of centralized identity providers into bureaucratic workflows puts private interests between the nation and its citizens and residents. When identity providers are relied upon for identity assurance, third parties gain the responsibility of representing which users are, in fact, specific persons. Involvement of centralized authorities creates privacy risks as those authorities gain unprecedented access to details about individual activity outside the direct needs of those authorities. This leads to “phone home” problems where a device, software, or system attempts to make an automatic connection to a central server or external system—often without the user's explicit awareness or consent.

The third requirement is freedom from unnecessary technical surveillance. Current aggregated assessments of individuals, such as credit scoring, depend on a notion of near complete knowledge of the domain of concern, creating a systemic dependence on unwarranted surveillance. According to the present system and method, algorithmic assessments of an individual's creditworthiness may be established only with complete information about the individual's activities. Unfortunately, it is impossible to know if all appropriate information is gathered (e.g., illicit and informal loans do not get reported to credit bureaus), and yet this attempt to get a 100% view of the individual is still relied upon.

The fourth requirement is accountability without unnecessary technical surveillance or information disclosure. Secret assessments encourage unwarranted surveillance, and current credit ratings are derived from untenable financial surveillance. The accountability is related to both identity providers and data subjects. Regarding accountability of identity providers, there is currently near zero accountability for data brokers presenting aggregated assessments of an individual's credit worthiness. The assessment is not externally verifiable as the algorithms and data are proprietary of the identity providers. Auditability of identity assurance protocols gives confidence and legal consequence for false assertions.

The resulting technical problem is how individuals can hold each other accountable for digital interactions without creating a digital panopticon. That is, the technical issue is how individuals ensure that information derived from the private evaluation of personal information is accurate and legitimate so that these private evaluations can be relied on without violating the privacy of the identity subject. For example, purveyors of age-restricted goods must restrict their sales to people who do not meet the age requirements. The hard part is figuring out which potential customers meet those requirements without unnecessary disclosure of personal information such as age, birthdate, or home address.

The disclosed techniques treat this as five interrelated technical problems. The first problem is how a relying party can have confidence that an actor in a given interaction is the expected party and how a relying party can establish that the subject individual has the qualities or characteristics that qualify them for services. For example, is a customer of legal age? Is a party authorized to make a purchase using a given payment mechanism? Is an individual eligible for lawful employment? Is an individual a member of a particular class (e.g., a citizen of a given country)? Is the website or software that an individual is interacting with a legitimate representation of a known organization? The second problem is why a relying party should trust an evaluator. The third problem is how a relying party can verify what they need to know about subject individuals without directly evaluating the source information, which often exposes personal information unnecessarily. The fourth problem is why a data subject should trust an evaluator. The fifth problem is why a relying party should trust an evaluator.

Currently, there is no reliable technical solution for consumers of derived information to verify the accuracy of that derivation without actually consuming the source from which that information is derived. Prior techniques have failed to completely and reliably address the technical problem of identity assurance across digital interactions. All these solutions in the offline, pre-digital world are by definition not digitally native. Moreover, physical credentials and certifications are expensive to produce, depend entirely on the procedural integrity of the issuing authority, and with enough resources can be forged.

Previous attempts to develop solutions for identity assurance in digital contexts also fail to completely address the problem. Usernames and passwords are widely recognized to be flawed since they are easily shareable, insecure, and generally limited to siloed systems. Some systems enable authentication by third parties, such as Google™ or Facebook™, but this introduces privacy issues where the third party is now a participant in all the interactions they facilitate authentication for.

The approach applied in high risk, often financial use cases that requires a scan and upload of offline credentials such as a passport is also limited. It introduces privacy issues, where many organizations now maintain a digital record of sensitive personal information. Additionally, these documents can easily be forged, and it is difficult to prevent credential sharing. Biometrics are an attempt to address credential sharing, requiring some form of liveness checking through a video or other mechanism that matches the credential uploaded. This is often done by a third party. Using biometrics introduces a serious privacy risk as well as being increasingly susceptible to forgery due to the advancements in generative Artificial intelligence (AI).

Finally, digital credentials have a number of limitations. JSON Web Tokens (JWTs) are semantically limited, requiring centralized disambiguation through the Internet Assigned Numbers Authority (IANA) registry. Additionally, the semantics of a JWT are private, generally intended to be consumed by the entity that created them and they have no clear subject. While the John B. Moore Documentary Studies Collaborative (mDocs) and Verifiable Credentials (VCs) do define a subject and a clear three-party model of issuers, holders, and verifiers, they are limited in that there is no visibility or auditability of the evidence that the claims in the USCIS I-9 fair witness VC was derived from. Additionally, the subjects and issuers of these digital credentials are cryptographic identifiers with no clear mechanism to bind that identifier to a real world entity, such as an individual. Without binding to an individual, it is impossible to have auditability and accountability over the issuance and presentation of these digital objects.

Centralized databases as an approach to address identity assurance also fail to address the full problem. Definitive authorities with databases such as social security numbers tend to rely on highly correlatable identifiers and often lack means of authentication against these identifiers, making it possible to represent oneself as a different identifier. Organizations that establish their own data sets and even offer these data sets to others to support identity assurance decisions have the problem of incentivizing surveillance and context collapse, as entities seek ever large data sets to make their decisions. Furthermore, these datasets are often opaque, and the entities that maintain them have no accountability over the accuracy of the data.

Finally, the problem with the Web of Trust approach used by Pretty Good Privacy (PGP) and other public key cryptography systems is their complexity. This in turn led to low adoption and without widespread adoption, the web of trust failed to materialize. Furthermore, there is no auditability of the attestations made by entities about public keys under this system.

The disclosed systems and methods introduce to the identity ecosystem a role of a fair witness who evaluates identity assertions in person, issues a fair witness Verifiable Credential (VC) attesting to the results of the evaluation, securely archives the evidence used in the evaluation for posterity, registers the evidence and results publicly, and is legally accountable for the accuracy of all registered evaluations. This novel technical approach is unique in the arts of authentication, authorization, and network communications, as discussed above.

In some embodiments, fair witnesses may be digital fiduciaries, a new class of oath bound professionals with a fiduciary duty to data subjects of the information that they manage. They may be members of a Digital Fiduciary Association (DFA), the self-regulating organization that manages credentialing and accountability. In some embodiments, fair witnesses may comprise people. In some embodiments a fair witness may comprise a fair witness entity. In some embodiments, a fair witness entity may comprise an individual, a person, a professional individual, etc.

Digital fiduciaries will be a self-regulated profession similar to doctors, lawyers, and accountants with their own training, certifications, licensing, and dispute resolution processes. These professionals are bound by oath to prioritize the interests of the data subjects first, with severe consequences for breaching this trust, including loss of license and, ultimately, their employment. The fair witnesses may not be fiduciaries, but they need to be accountable for their attestations.

The fair witnesses of the present system and method lead in-person fair witness ceremonies that produce auditable digital attestations derived from the evaluation of sensitive private information according to context specific protocols, such as the U.S. Citizenship and Immigration Services (USCIS) I-9, which is a document required by the USCIS and used by employers in the United States to verify the identity and legal authorization of individuals hired for employment. A record of each attestation is published to a fair witness network providing 100% visibility into the existence of all validated attestations. Digital fiduciaries are expected to archive all of the source evidence they verified to derive the fair witness attestations they make. Together, these features enable auditability of the fair witness attestations, such that for every record published on the fair witness network, an auditor is able to check the validity of the attestation issued against the archived evidence held by the fair witness.

Current assurance practices do not have any expectation of allowing auditors to double-check the source data. There may be an appeal to a credit rating from an agency, but it is impossible to personally inspect all of the data involved and the algorithm used. For example, some credit reports (e.g., TRW) do not provide source material for a second opinion on the credit rating they assigned.

Current assurance frameworks tend to over-specify or over-simplify specific details. Fair witness ceremonies of the present system and method enable different rules for assurance to be realized within the same trustworthy framework of post-facto verifiability of evaluations.

The fair witness network of the present system and method is a public, append only data storage system in which signed records of the outcomes of fair witness ceremonies and audits can be registered. This enables procedural accountability.

Anybody can check the fair witness network to see that a fair witness record signed by a known identifier for a digital fiduciary exists for a specific fair witness credential. Verifiers that rely on claims made by a fair witness credential, who subsequently come to suspect these claims are misleading, can challenge the fair witness record on the fair witness network, triggering a specific audit of the record against the archival evidence held by the fair witness issued the credential. Additionally, due to the visibility of all fair witness records published to the fair witness network, it is possible to conduct regular statistical audits of these records. This increases the confidence in the fair witness records and provides a mechanism to identify erroneous fair witness credentials and hold those responsible legally accountable with potentially career ending consequences.

In some embodiments, the DFA intranet manages the allocation of audit tasks to prevent collusion between auditors and fair witness entities.

This allocation may also be managed in a decentralized manner according to the systems and processes disclosed herein.

Conventional solutions generally do not require public registration of credential issuance. In addition, those that register credential issuance publicly do not perform this process in a privacy-respecting way (e.g., the government of British Columbia publishes credentials about companies). On the other hand, the present system and method enables auditable public registration without revealing the contents of the attestation.

Accordingly, the present system and method allow public accountability for private verifications, enabling in-person, and physical ceremonies to underpin digital interactions in any context.

Specifically, according to the present system and method, relying parties now have the confidence in fair witness credentials, precisely because they can be and are audited/confirmed, and in case of any disputes, errors and attacks can be discovered and the appropriate parties held accountable. This confidence is achieved without reliance on a centralized authority, allowing all identity subjects to pick and choose the fair witnesses they want to work with and relying parties to pick the protocols they accept.

For the first protocol of the present system and method, the USCIS I-9 credential, any eligible worker can be allowed to demonstrate their eligibility to work in the U.S. without revealing any attributes that might undermine our social goals to encourage diversity and inclusion, such as nation of origin or immigration status. The recently published alternative process for the USCIS actually undermines privacy goals because it requires E-Verify employers to maintain an archive of all employee documentation, creating a honeypot of toxic data. This invention keeps that information out of the employer's system so that suitable professionals can properly manage it: professionals with a fiduciary obligation to the identity subject.

In addition, the present system and method enable legal-technical protocols to bind legal persons to enforceable commitments. Fiduciaries and service providers (also known as signatories) are legally bound to adhere to expected standards of behavior.

Furthermore, fair witness ceremonies of the present system and method are applicable to virtually any legal-technical protocol that addresses how data subjects are recognized, remembered, and responded to. The fair witness approach can be used anywhere that sensitive information is needed to evaluate a data subject's suitability for services.

Last but not least, in the disclosed techniques, sensitive personal information is only stored in an offline archive that is not accessible on the internet. In some embodiments, the information may also be stored in an encrypted data vault securely under the control of the fiduciary. Additionally, the encryption keys securing the data may use multi signature technology to allow the DFA to intervene in case of death.

Conventional solutions do not have these features and achieve the technical effects in the present system and method. First of all, without the existence of professional fiduciaries as a class, professional fiduciaries cannot be used for any solutions. There is a simple catch-22: (1) a system that needs digital fiduciaries and (2) the system that maintains digital fiduciaries because they are needed. With a social institution of professional digital fiduciaries, certain capabilities become possible that were not possible before. One of those capabilities may be fair witness networks in the present system and method. Without digital fiduciaries, it is impossible to build a system that depends on them.

In addition, conventional solutions lack expertise. Existing self-regulating professions do not have the expertise to develop robust privacy-preserving solutions for digital identity. The System and Organization Controls (SOC)-2 [18] from the American Institute of Certified Public Accountants (AICPA), is one fiduciary-led privacy initiative. However, the SOC-2 requires auditors to be accountants and does not engage with the deeper technical and political questions about how personal information for specific purposes should be managed in different circumstances. Instead, the SOC-2 follows a document-and-demonstrate approach to generalized accountability based on a company's stated policies. There are no use-case specific protocols that firms implement and support, nor is there a dispute mechanism designed to enforce compliance.

Furthermore, there is state allergy in the conventional solutions. Decentralized technologies are often misunderstood and maligned by established state actors, making it difficult for established technology providers to explore decentralized solutions when working with state actors. In particular, it is well understood in the industry that the U.S. Federal government has negative reactions to blockchain or cryptocurrency based technology solutions. As a result, vendors proposing systems of identity assurance for federal use avoid decentralized approaches.

Conventional solutions also show top-down legacy thinking. Innovators in the field of identity are primarily focused on notions of identity that suggest centralized, top-down approaches. Those in this field view identity as given to individuals by the state, so privacy of the individual-as it relates to the state-is often explicitly not considered: the state gives you your passport, your social security number, your top secret clearance, etc., and thus, in these use cases, it can be challenging to think through scenarios where the individual is somehow in control over their personal information. Instead, many technologists focus on surveillance and tracking solutions to improve the situational awareness of the state when determining the identity of individuals interacting with federal systems. While these approaches seem reasonable in the narrow light of individual federal systems, they often create untenable privacy risks and even harms.

As described above, the disclosed techniques have technical advantages over the other approaches. First, every fair witness VC is digitally auditable. That is, i) 100% post-facto audit and accountability are possible for all ceremonies executed according to any fair witness protocol. Specifically, audits can be triggered by policy, and challenges can trigger dispute evaluations. Also, ii) registration enables 100% coverage, and iii) cryptographic binding of evidence guarantees auditors to see the same evidence and perform the same evaluation as the originating fair witness. Second, everyone, including fiduciaries, identity subjects, and relying parties, gets to choose to participate. That is, i) any fiduciary can perform any witness event, ii) identity subjects can work with any fiduciary, and iii) fair witness verifiable credentials can be used at any relying party. Without fiduciaries-the world prior to the current system and invention-identity subjects generally are forced to use whatever identity assurance mechanism a relying party demands, without recourse to choosing a trusted agent. Currently, employers hire USCIS I-9 agents directly, given the identity subject no choice in the matter. In our present system and method, the individual identity subject gets to choose their trusted fair witness. Further, for current electronic (remote) verification using USCIS's eVerify system, employers must retain copies of all documents presented, creating a toxic data retention problem. In our present system and method, relying parties only get the minimal information required while sensitive evidentiary data is securely stored by a fair witness. Third, data sharing is under the identity subject's control. That is, identity subjects need only reveal selected information to relying parties they choose. Fourth, service providers, such as corporations, who choose to offer services according to fair witness protocols, such as digital fiduciaries or fair witnesses, are legally obligated to satisfy the requirements of the protocol. The service providers are configured to have distinct roles in the ecosystem. They are the legal entity responsible for the service, which will often be a corporation, and corporations cannot be digital fiduciaries. Those service providers must appoint a digital fiduciary to oversee their service, but they may not be fiduciaries. For example, FedEx™ may offer a fiduciary service, but not themselves being a digital fiduciary because the fiduciary is an oath-bound human being. The combination of legal and technical requirements in Digital Fiduciary Protocols means that the DFA can actually enforce compliance, giving us a unique power that is unavailable to the world's premier technical standards bodies, including W3C, IETF, ISO, and all the organizations that have been modeled on them. Fifth, the present systems and methods create a customizable framework suitable for any jurisdiction or business requirement for identity assurance. That is, i) any jurisdictional or business requirements can be addressed by new protocols; ii) relying parties pick and choose which credentials satisfy their business requirements; and iii) no global authority decides how to identify any particular person or group of people. Sixth, the present systems and methods enable privacy-respecting use of complex identity information. Relying parties can count on the veracity of the FW Credential without needing to see the underlying evidence, which inevitably contains sensitive information. Last but not least, the present systems and methods eliminate the need for large scale honeypots for identity assurance.

Individual fiduciaries independently archive and maintain evidentiary data.

One example process for implementation utilizing a computing environment includes a method for identity verification of a subject and assurance utilizing one or more fair witness networks, comprising: generating, by a fair witness using a fair witness device, a digital fair witness credential to a subject, based on evidence of identity of the subject according to an established fair witness protocol; storing, by an archive device, the evidence of identity and the signed digital fair witness credential; publishing using a publishing device, to a fair witness network, a fair witness record corresponding to the digital fair witness credential and the evidence evaluated by the fair witness; presenting, by the subject, an identity claim and proofs derived from the digital fair witness credential to a relying party; verifying, by a system of the relying party, the proofs that the presented claim is authentic; validating, by the system of the relying party, that the presented digital fair witness credential has been registered by a certified digital fiduciary on the fair witness network by locating the fair witness record cryptographically associated with the digital fair witness credential; auditing, by an auditor, using an auditing device, the fair witness record published in the fair witness network in order to verify attestations within the digital fair witness credential according to the protocol, based on the evidence originally evaluated by the generating fair witness.

FIG. 14 is a high-level block diagram 1100 showing a computing system comprising a computer system useful for implementing an embodiment of the system and process, disclosed herein. Embodiments of the system may be implemented in different computing environments. The computer system includes one or more processors 1102, and can further include an electronic display device 1104 (e.g., for displaying graphics, text, and other data), a main memory 1106 (e.g., random access memory (RAM)), storage device 1108, a removable storage device 1110 (e.g., removable storage drive, a removable memory module, a magnetic tape drive, an optical disk drive, a computer readable medium having stored therein computer software and/or data), user interface device 1111 (e.g., keyboard, touch screen, keypad, pointing device), and a communications interface 1112 (e.g., modem, a network interface (such as an Ethernet card), a communications port, or a PCMCIA slot and card). The communications interface 1112 allows software and data to be transferred between the computer system and external devices. The system further includes a communications infrastructure 1114 (e.g., a communications bus, cross-over bar, or network) to which the aforementioned devices/modules are connected as shown.

Information transferred via communications interface 1112 may be in the form of signals such as electronic, electromagnetic, optical, or other signals capable of being received by communications interface 1112, via a communication link 1116 that carries signals and may be implemented using wire or cable, fiber optics, a phone line, a cellular/mobile phone link, a radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions, when provided to at least one processor, produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 1112. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

FIG. 15 shows a block diagram of an example computing network system 1200 in which an embodiment may be implemented. The system 1200 includes one or more client devices 1201 such as consumer electronics devices, connected to one or more server computing systems 1230. A server 1230 includes a bus 1202 or other communication mechanism for communicating information, and at least one processor (CPU) 1204 coupled with the bus 1202 for processing information. The server 1230 also includes a main memory 1206, such as a random-access memory (RAM) or other dynamic storage device, coupled to the bus 1202 for storing information and instructions to be executed by the processor 1204, such as instructions that cause at least one processor to carry out operations corresponding to any combination of the steps and methods discussed above. The main memory 1206 also may be used for storing temporary variables or other intermediate information during execution or instructions to be executed by the processor 1204. The server computer system 1230 further includes a read only memory (ROM) 1208 or other static storage device coupled to the bus 1202 for storing static information and instructions for the processor 1204. A storage device 1210, such as a magnetic disk or optical disk, is provided and coupled to the bus 1202 for storing information and instructions. The bus 1202 may contain, for example, thirty-two address lines for addressing video memory or main memory 1206. The bus 1202 can also include, for example, a 32-bit data bus for transferring data between and among the components, such as the CPU 1204, the main memory 1206, video memory and the storage 1210. Alternatively, multiplex data/address lines may be used instead of separate data and address lines.

The server 1230 may be coupled via the bus 1202 to a display 1212 for displaying information to a computer user. An input device 1214, including alphanumeric and other keys, is coupled to the bus 1202 for communicating information and command selections to the processor 1204. Another type or user input device comprises cursor control 1216, such as a mouse, a trackball, or cursor direction keys for communicating direction information and command selections to the processor 1204 and for controlling cursor movement on the display 1212.

According to one embodiment, the functions are performed by the processor 1204 executing one or more sequences of one or more instructions contained in the main memory 1206. Such instructions may be read into the main memory 1206 from another computer-readable medium, such as the storage device 1210. Execution of the sequences of instructions contained in the main memory 1206 causes the processor 1204 to perform the process steps described herein. One or more processors in a multi-processing arrangement may also be employed to execute the sequences of instructions contained in the main memory 1206. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor's multi-core processor to perform the features of the computer system. Accordingly, such computer programs represent controllers of the computer system.

Generally, the term “computer-readable medium” as used herein refers to any medium that participated in providing instructions to the processor 1204 for execution. Such a medium may take many forms, including but not limited to, non-volatile media, volatile media, and transmission media. Non-volatile media includes, for example, optical or magnetic disks, such as the storage device 1210. Volatile media includes dynamic memory, such as the main memory 1206. Transmission media includes coaxial cables, copper wire and fiber optics, including the wires that comprise the bus 1202. Transmission media can also take the form of acoustic or light waves, such as those produced during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 1204 for execution. For example, the instructions may initially be carried on a magnetic disk of a remote computer. The remote computer can load the instructions into its dynamic memory and send the instructions over a telephone line using a modem. A modem local to the server 1230 can receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1206, from which the processor 1204 retrieves and executes the instructions. The instructions received from the main memory 1206 may optionally be stored on the storage device 1210 either before or after execution by the processor 1204.

The server 1230 also includes a communication interface 1218 coupled to the bus 1202. The communication interface 1218 provides a two-way data communication coupling to a network link 1220 that is connected to the world wide packet data communication network now commonly referred to as the Internet 1228. The Internet 1228 uses electrical, electromagnetic or optical signals that carry digital data streams. The signals through the various networks and the signals on the network link 1220 and through the communication interface 1218, which carry the digital data to and from the server 1230, are exemplary forms or carrier waves transporting the information.

In another embodiment of the server 1230, the communication interface 1218 is connected to a network 1222 via a communication link 1220. For example, the communication interface 1218 may be an integrated services digital network (ISDN) card or a modem to provide a data communication connection to a corresponding type of telephone line, which can comprise part of the network link 1220. As another example, the communication interface 1218 may be a local area network (LAN) card to provide a data communication connection to a compatible LAN. Wireless links may also be implemented. In any such implementation, the communication interface 1218 sends and receives electrical, electromagnetic, or optical signals that carry digital data streams representing various types of information.

The network link 1220 typically provides data communication through one or more networks to other data devices. For example, the network link 1220 may provide a connection through the local network 1222 to a host computer 1224 or to data equipment operated by an Internet Service Provider (ISP). The ISP in turn provides data communication services through the Internet 1228. The local network 1222 and the Internet 1228 both use electrical, electromagnetic, or optical signals that carry digital data streams. The signals through the various networks and the signals on the network link 1220 and through the communication interface 1218, which carry the digital data to and from the server 1230, are exemplary forms or carrier waves transporting the information.

The server 1230 can send/receive messages and data, including e-mail, and program code through the network via the network link 1220 and the communication interface 1218. Further, the communication interface 1218 may comprise a USB/Tuner and the network link 1220 may be an antenna or cable for connecting the server 1230 to a cable provider, satellite provider or other terrestrial transmission system for receiving messages, data and program code from another source.

The example versions of the embodiments described herein may be implemented as logical operations in a distributed processing system, such as the system 1200 including the servers 1230. The logical operations of the embodiments may be implemented as a sequence of steps executing in the server 1230, and as interconnected machine modules within the system 1200. The implementation is a matter of choice and can depend on performance of the system 1200 implementing the embodiments. As such, the logical operations constituting said example versions of the embodiments are referred to, for example, as operations, steps or modules.

Similar to a server 1230 described above, a client device 1201 may include at least one processor, memory, storage device, display, input device and/or communication interface (e.g., e-mail interface) for connecting the client device to the Internet 1228, the ISP, or LAN 1222, for communication with the servers 1230.

The system 1200 may further include computers (e.g., personal computers, computing nodes) 1205 operating in the same manner as client devices 1201, wherein a user can utilize one or more computers 1205 to manage data in the server 1230.

Referring now to FIG. 16, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. The nodes 10 may communicate with one another. The nodes may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above. It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways. Unless indicated otherwise, “based on” can include one or more of being dependent upon, being responsive to, being interdependent with, being influenced by, using information from, resulting from, or having a relationship with.

For example, while some embodiments are discussed in a context involving a controller, this element need not be present in each embodiment, as other devices (e.g., embedded devices) may also operate within the disclosed embodiments. Such variations are fully within the scope and spirit of the described embodiments.

The disclosed embodiments may be implemented in a system, a method, and/or a computer program product. The computer program product may include a computer-readable storage medium (or media) having computer-readable program instructions thereon for causing at least one processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions. Moreover, while certain terms from the figures may be referred to in parentheses without the term “e.g.,” it is appreciated all such terms referred to in parentheses are exemplary, and that other examples (including other numbers related to other figure elements) are possible.

These computer-readable program instructions may be provided to at least one processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Moreover, some blocks may be executed iteratively, and some blocks may not be executed at all. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials will be developed and the scope of the these terms is intended to include all such new technologies a priori.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A computer-implemented method for identity assurance, comprising:
creating a digital fair witness credential for a subject, based on evidence of identity of the subject;
digitally signing the digital fair witness credential, using at least one cryptographic identifier associated with a fair witness;
creating an evidence data object including the evidence of identity and the signed digital fair witness credential;
storing the evidence data object;
making accessible, to a fair witness network, a fair witness record corresponding to the digital fair witness credential and the evidence, wherein the fair witness record is cryptographically associated with the signed digital fair witness credential and the evidence data object.

2. The computer-implemented method of claim 1, further comprising:
receiving, from a confirming device, a digitized request for the fair witness record; and
transmitting the fair witness record to the confirming device without revealing the evidence of identity, wherein the record is usable by the confirming device to validate a credential provided locally to the confirming device.

3. The computer-implemented method of claim 1, wherein:
providing the fair witness record to the confirming device comprises transmitting a fair witness network transaction to the confirming entity; and
the fair witness record is extractable from the fair witness network transaction by the confirming device.

4. The computer-implemented method of claim 1, further comprising validating, using a confirming device, that the creation of a fair witness credential was registered on a fair witness network using a fair witness record.

5. The computer-implemented method of claim 1, wherein the digital fair witness credential contains one or more images.

6. The computer-implemented method of claim 1, wherein the digital fair witness credential cryptographically commits to one or more images.

7. The computer-implemented method of claim 1, wherein a consensus-based state of the fair witness network is maintained by multiple nodes of the network.

8. The computer-implemented method of claim 7, wherein the nodes maintain an append-only data store that publishes the fair witness record.

9. The computer-implemented method of claim 7, wherein at least one of the nodes is configured to compute one or more cryptographic operations to verify transactions published to a node of the network.

10. The computer-implemented method of claim 1, further comprising:
establishing a data transfer connection with a subject device; and
receiving, from the subject device and using the data transfer connection, a cryptographic identifier; and
designating the cryptographic identifier as a subject of the signed digital fair witness credential.

11. The computer-implemented method of claim 1, further comprising scanning a document to produce documentary evidence or capturing a photo to produce photographic evidence, wherein the documentary evidence or the photographic evidence is part of the evidence of identity included in the evidence data object.

12. The computer-implemented method of claim 1, wherein the digital fair witness credential includes a hash of the evidence of identity.

13. The computer-implemented method of claim 1, further comprising scanning a QR code to obtain a digital identifier usable to establish a connection with a subject device.

14. The computer-implemented method of claim 1, wherein the signed digital fair witness credential is usable by the confirming device to verify that the signed digital fair witness credential is cryptographically equivalent to the locally provided credential, using cryptographic material associated with the at least one cryptographic identifier used to sign the credential.

15. The computer-implemented method of claim 10, wherein the confirming device is configured to verify that a source providing the locally provided credential has access to the cryptographic material associated with at least one the cryptographic identifier.

16. The computer-implemented method of claim 1, wherein the evidence data object, after decryption, is usable by an auditor device to verify, using an audit process, a result of a fair witness protocol used to generate the digital fair witness credential.

17. The computer-implemented method of claim 16, wherein the result of an audit process is registered on the fair witness network.

18. The computer-implemented method of claim 1, wherein:
the digital fair witness credential is created and signed by a fair witness device, and
the fair witness device is controlled by a recognized fair witness and registered with the fair witness network.

19. The computer-implemented method of claim 1, further comprising transmitting the digital fair witness credential from the fair witness device to a subject device.

20. The computer-implemented method of claim 18, wherein the subject device is used to present the digital fair witness credential to the confirming entity.

21. The computer-implemented method of claim 10, further comprising verifying, prior to generating the digital fair witness credential, that the at least one cryptographic identifier is under the control of the subject.

22. The computer-implemented method of claim 1, wherein the evidence data object is encrypted.

23. A non-transitory computer-readable medium storing one or more instructions for identity assurance that, when executed by one or more processors of a device, cause the device to perform operations comprising:
generating a digital fair witness credential for a subject, based on evidence of identity of the subject;
digitally signing the digital fair witness credential, using at least one cryptographic identifier associated with a fair witness device;
creating an evidence data object including the evidence of identity and the signed digital fair witness credential;
storing the evidence data object; and
making accessible, to a fair witness network, a fair witness record corresponding to the digital fair witness credential and the evidence, wherein the fair witness record is cryptographically associated with the signed digital fair witness credential and the evidence data object.
